(19) United States
(12) Patent Application Publication
(10) Pub. No.: US 2026/0184555 A1
(43) Pub. Date: Jul. 2, 2026

(54) SYSTEMS AND METHODS FOR AN AUTOMATED BEVERAGE DISPENSER

(71) Applicant: Yum Connect, LLC, Louisville, KY (US)

(72) Inventors: Aaron Thomas, Louisville, KY (US); Karl Szatrowski, Louisville, KY (US)

(73) Assignee: Yum Connect, LLC, Louisville, KY (US)

(21) Appl. No.: 19/005,012

(22) Filed: Dec. 30, 2024

(51) Int. Cl. B67D 1/08; B67D 1/12

(52) U.S. Cl. CPC B67D 1/0882; B67D 1/0888; B67D 1/1227; B67D 2210/00078

(57) ABSTRACT

An automated beverage dispenser includes a cup dispensing station configured to dispense cups for use. The cup dispensing station includes a housing, a plurality of cups positioned within the housing, the plurality of cups being positioned in a nested relationship, a driver configured to de-nest a cup from the plurality of cups, and a controller. The controller is configured to receive a predefined threshold regarding an operating parameter of the driver and receive a value regarding the operation of the driver. The controller is configured to determine that the value regarding operation of the driver exceeds the predefined threshold, and in response to determining that the value exceeds the predefined threshold, cease operation of the driver to stop de-nesting cups from the plurality of cups.

### TECHNICAL FIELD

The present disclosure relates generally to the field of beverage dispensers and, more particularly, to systems and methods for operating and/or controlling an automated beverage dispenser.

### BACKGROUND

Restaurants and other dining facilities may distribute large numbers of beverages to patrons during periods of operation. As a result, dining facilities may have a beverage fountain or other similar system that may be used by patrons and/or employees to efficiently produce beverages.

### SUMMARY

One embodiment relates to an automated beverage dispenser. The automated beverage dispenser includes a cup dispensing station configured to dispense cups for use. The cup dispensing station includes a housing, a plurality of cups positioned within the housing, the plurality of cups being positioned in a nested relationship, a driver configured to de-nest a cup from the plurality of cups, and a controller. The controller includes one or more processing circuits having one or more memory devices coupled to one or more processors. The one or more memory devices are configured to store instructions thereon that, when executed by the one or more processors, cause the one or more processors to receive a predefined threshold regarding an operating parameter of the driver and receive a value regarding the operation of the driver. The instructions cause the one or more processors to determine that the value regarding operation of the driver exceeds the predefined threshold, and in response to determining that the value exceeds the predefined threshold, cease operation of the driver to stop de-nesting cups from the plurality of cups.

Another embodiment relates to an automated beverage dispenser that includes a beverage dispensing station and a controller. The beverage dispensing station is configured to dispense a beverage into a cup. The beverage dispensing station includes one or more valves and at least one nozzle. The controller includes one or more processing circuits having one or more memory devices coupled to one or more processors. The one or more memory devices are configured to store instructions thereon that, when executed by the one or more processors, cause the one or more processors to dispense a first volume of beverage into the cup using the at least one nozzle, and receive, from one or more sensors, an indication of a beverage fill level of the dispensed first volume of beverage into the cup. Based on the received indication of the beverage fill level of the dispensed first volume of beverage, the controller causes a second volume of beverage to be dispensed into the cup using the at least one nozzle.

Still another embodiment relates to a controller for an automated beverage dispenser. The controller includes one or more processing circuits having one or more memory devices coupled to one or more processors. The one or more memory devices are configured to store instructions thereon that, when executed by the one or more processors, cause the one or more processors to receive, over a network, an order from a point of sale (POS) system, and parse, from the order, one or more beverage orders and a destination identification (ID). The instructions cause the one or more processors to operate one or more beverage dispenser devices of the automated beverage dispenser to dispense a cup and a beverage according to one of the one or more beverage orders. The instructions cause the one or more processors to operate a lidding assembly of the automated beverage dispenser to print the beverage and the destination ID onto a sealing film. The instructions cause the one or more processors operate the lidding assembly to couple the sealing film onto an open end of the cup filled with the beverage such that the sealing film forms a lid for the cup.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a perspective view of a beverage productions system, according to a first embodiment.

FIG. 2 is a perspective view of a beverage production system, according to a second embodiment.

FIG. 3 is another perspective view of the beverage production system, according to the second embodiment.

FIG. 4 is a perspective view of a turntable assembly of the beverage production system of FIG. 1, according to an example embodiment.

FIG. 5A is an exploded view of the turntable assembly of FIG. 4, according to an example embodiment.

FIG. 5B is a perspective view of a slide assembly positioned within turntable assembly of FIG. 4, according to an example embodiment.

FIG. 6 is a partial exploded view of a cup dispensing station of the beverage production system of FIG. 1, according to an example embodiment.

FIG. 7 is a partial exploded view of a cup dispensing station of the beverage dispenser of FIG. 1, according to an example embodiment.

FIG. 8 is an interior view of a cup dispensing station of the beverage productions systems shown in FIGS. 1-3, according to an example embodiment.

FIG. 9 is a view of a de-nesting assembly of the cup dispensing station of the beverage production systems shown in FIGS. 1-3, according to an example embodiment.

FIG. 10 is a view of a de-nesting assembly of the cup dispensing station of the beverage production systems shown in FIGS. 1-3, according to an example embodiment.

FIG. 11 is a schematic view of an ice dispensing station of the beverage production systems of FIG. 1, according to an example embodiment.

FIG. 12 is a is a schematic view of a beverage dispensing station of the beverage production systems of FIGS. 1-3, according to an example embodiment.

FIG. 13 is a perspective view of a lidding and printing assembly of the beverage production systems of FIGS. 1-3, according to an example embodiment.

FIG. 14 is a partial view of the beverage production system of FIG. 3, according to an example embodiment.

FIG. 15 is a block diagram of a control system for the beverage production systems of FIGS. 1-3, according to an example embodiment.

FIG. 16 is a flow diagram of a method for operating an automated beverage dispenser, according to an example embodiment.

FIG. 17 is a flow diagram of a method for operating an automated beverage dispenser to perform a flush cycle, according to an example embodiment.

FIG. 18 is a flow diagram of a method for operating an automated beverage dispenser to fulfill one or more beverage, according to an example embodiment.

FIG. 19 is a flow diagram of a method for operating an automated beverage dispenser to fulfill one or more beverage orders, according to an example embodiment.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

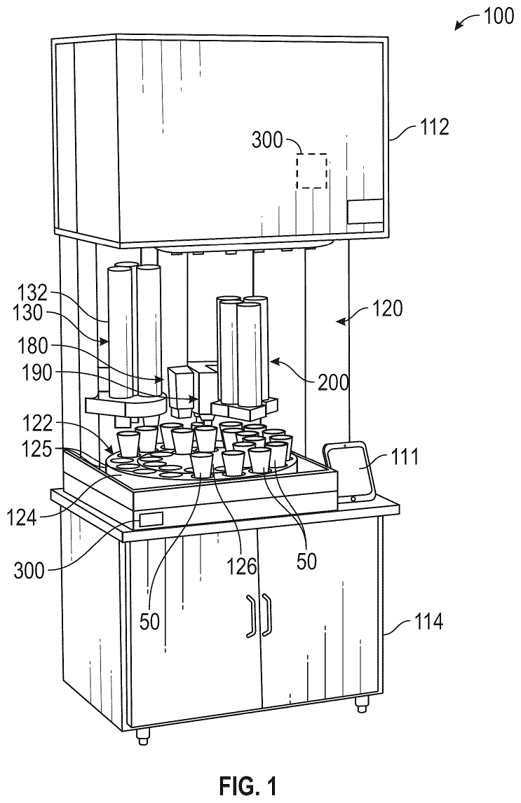

Referring now to FIG. 1, a beverage production system 100 according to some embodiments is shown. As will be described in more detail below, the beverage production system 100 may be used to automatically prepare and dispense complete or substantially complete beverage orders during operation thereby reducing the number of manual actions performed by servers, customers, etc. In general, the beverage production system 100 includes an ice chamber 112, a cabinet 114, and a beverage handling assembly 120 positioned between the ice chamber 112 and the cabinet 114. As referred to herein, “beverage order” refers to a cup of a specified size filled with a beverage/drink with or without a lid. As referred to herein, “beverage” refers to a particular liquid or mixture of liquids (e.g., water, carbonated water, soda, juice, tea, coffee, etc.).

The beverage handling assembly 120 includes a plurality of stations for performing various stages or steps of the beverage production process. In particular, the beverage handling assembly 120 includes a cup dispensing station 130, an ice dispensing station 180, a beverage dispensing station 190, and a lidding and printing assembly 200. Beverage orders may be produced by dispensing a cup from the cup dispensing station 130 and progressing the cup through the stations 180, 190, 200 with a turntable assembly 122.

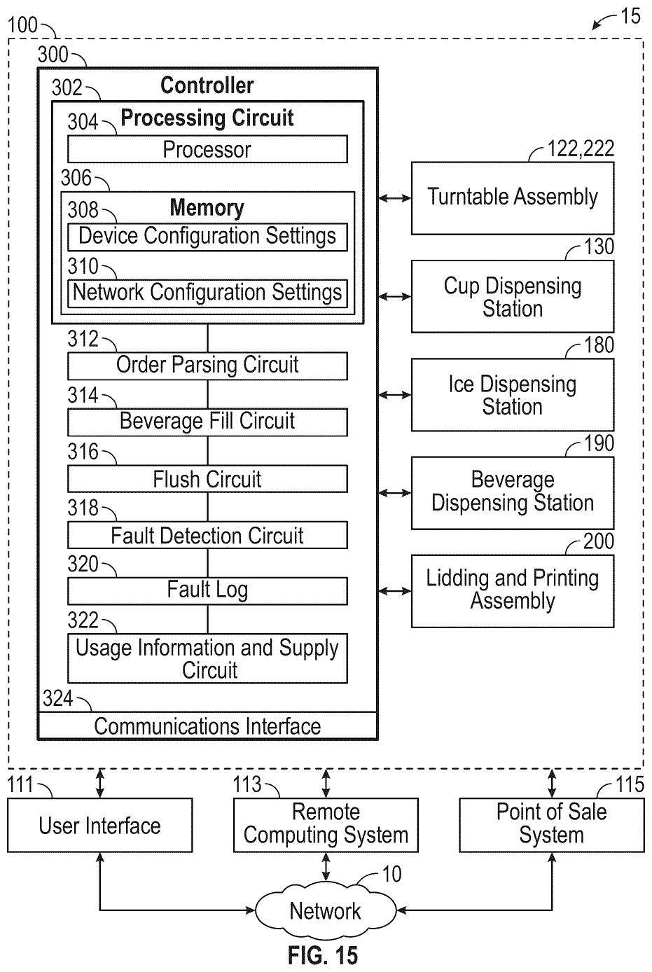

During operation, commands to produce selected beverages may be received by suitable electronics (e.g., the controller 300) of the beverage production system 100. For instance, an employee or customer may select the desired beverage(s) on a user device 111 which then initiates the beverage production process generally described above. In some embodiments, the user device 111 may comprise a touch-sensitive electronic display (e.g., a tablet integrated with the beverage production system 100). In other embodiments, the user device 111 may be a remote user computing device relative to the beverage production system 100 and be, for example, a laptop computer, a desktop computer, a mobile device, etc. The beverage production system 100 may also be communicably coupled to a point of sale (POS) system, which may be another form of user device that controls, at least partly, operation of the beverage production system 100. In some embodiments, the beverage production system 100 may receive commands to produce beverages via other electronic devices that are communicatively coupled to the beverage production system 100 via a suitable network or connection. For instance, in some embodiments, the beverage production system 100 may receive commands to produce beverages from a (POS) system of the restaurant or dining facility that may receive orders via customers or employees (e.g., in addition to or in place of the commands from the other user device, such as the touch-sensitive laptop computer). In some embodiments, the POS system 115 may be part of a system (e.g., the system 15 of FIG. 15) that also includes the beverage production system 100.

Once commands to produce beverage(s) are received by the beverage production system 100, turntables 124, 126 may be rotated to progress the cup receptacles 125 through the stations 130, 180, 190, 200. Simultaneously, the assemblies and mechanisms within each of the stations 130, 180, 190, 200 may actuate to produce beverages. Specifically, as described above, the cup dispensing station 130 may dispense cups 50 from magazines 132 into cup receptacles 125 in one or both of the rows 154, 156. Thereafter, the cups 50 are aligned with the ice dispensing station 180, whereby ice is dispensed into the cups 50. In some instances, depending on the selected preferences for each requested beverage, ice may not be dispensed into a cup or cups 50 when aligned with the ice dispensing station 180. Next, the cups 50 and ice (if dispensed) are aligned with the beverage dispensing station 190, whereby the selected beverage is dispensed into the cups 50 (e.g., via nozzles 194, 196). Next, depending on the lidding system that is employed, cups 50 may be progressed to the lidding and printing assembly 200 whereby a lid may be dispensed and secured onto the cups 50 or a film lid is placed and secured on the cup, such as by heat sealing. In some embodiments, some or all of the lidding process may be performed manually, such that lidding and printing assembly 200 may be simplified or omitted entirely from beverage handling assembly 120.

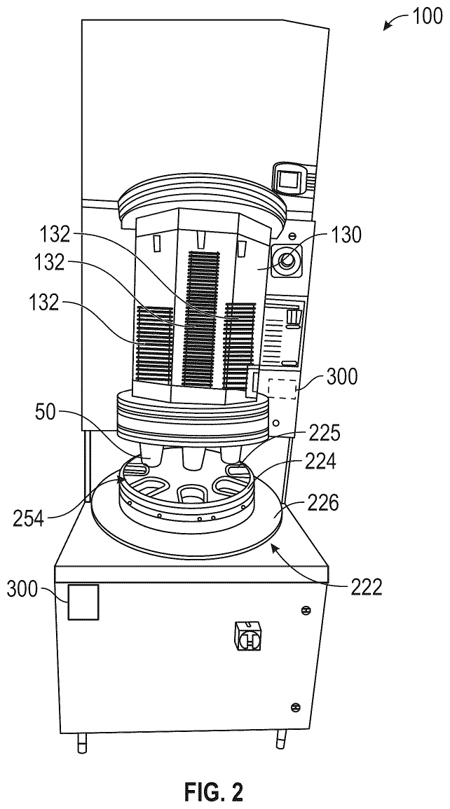

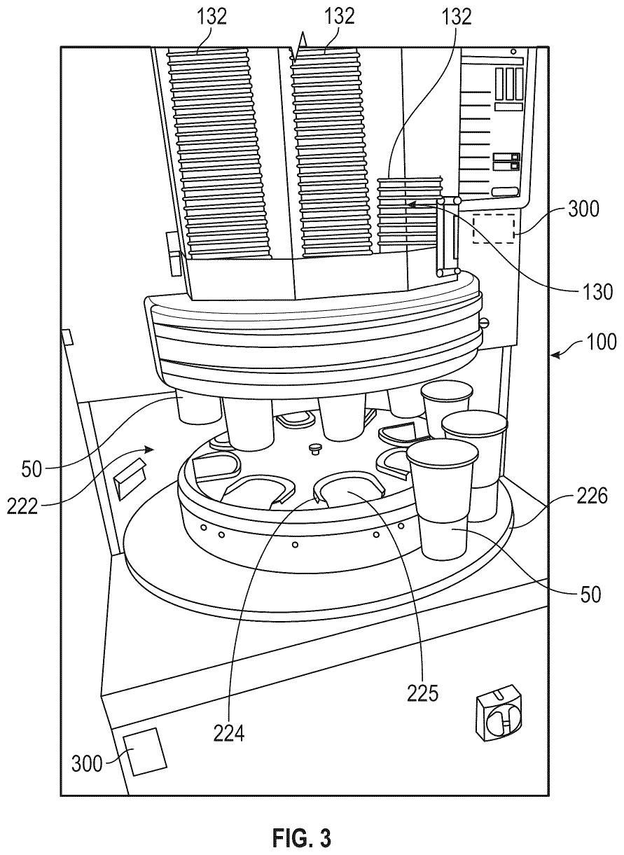

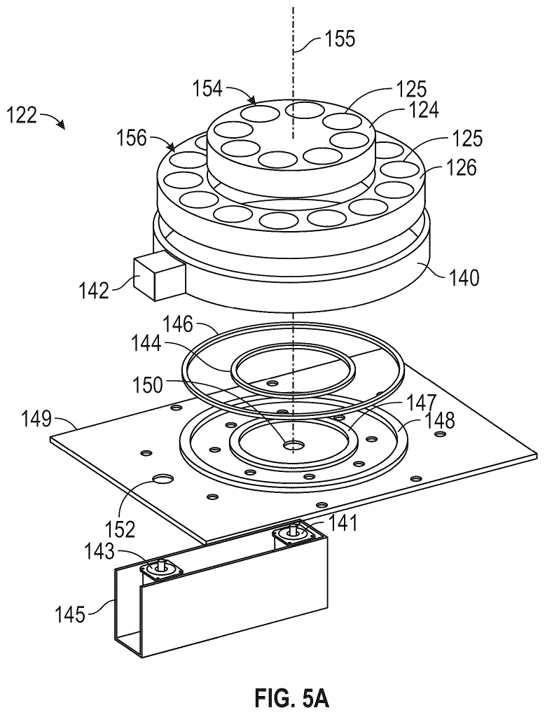

Referring to FIGS. 2 and 3, perspective views of another embodiment of the beverage production system 100 are shown, according to an example embodiment. In this embodiment, a turntable assembly 222 includes a flat outer turntable 226 and an inner turntable 224. As shown in FIGS. 2 and 3, the outer turntable 226 does not have the outer row 156 of cup receptacles 125 and, instead, the outer turntable 226 is a flat rotating surface or dial. The outer turntable 226 may be constructed of various materials including plastic or polymeric materials, rubber, stainless steel, and/or other materials. In some embodiments, the outer turntable 226 is constructed of materials that promote frictional engagement of the cup 50 with the outer turntable 226 to prevent cups from sliding off the outer turntable 226 while still allowing the cups 50 to be transitioned onto the outer turntable 226. The inner turntable 224, in this embodiment, includes the inner row 254 of cup receptacles 225. In the present embodiment of the beverage production system 100, the inner row 254 of cup receptacles 225 are separate, removable components from the inner turntable 224, although it is contemplated that these components may be integrally formed in other embodiments. As described in more detail below, with regards to FIG. 5A, the inner and outer turntables 224, 226 are configured to rotate independently from one another and may comprise drives, motors, and gearboxes.

The beverage production system 100 employs another embodiment of the cup dispensing station 130. In this embodiment, the plurality of tubular magazines 132 are fixed above the turntable assembly 122 and arranged to dispense cups 50 of various sizes into the inner row 154 of cup receptacles 125. Cups 50 are dispensed automatically from the tubular magazines 132 in various manners as previously discussed. For example, when a particular size beverage is ordered, the beverage production system 100 causes the tubular magazine 132 containing the ordered cup 50 size to dispense or drop the cup 50 into the cup receptacle 125 immediately below using techniques described herein. In this embodiment, cups 50 are filled with beverages are in the inner turntable 124 and are moved to the outer turntable 126 for retrieval by users.

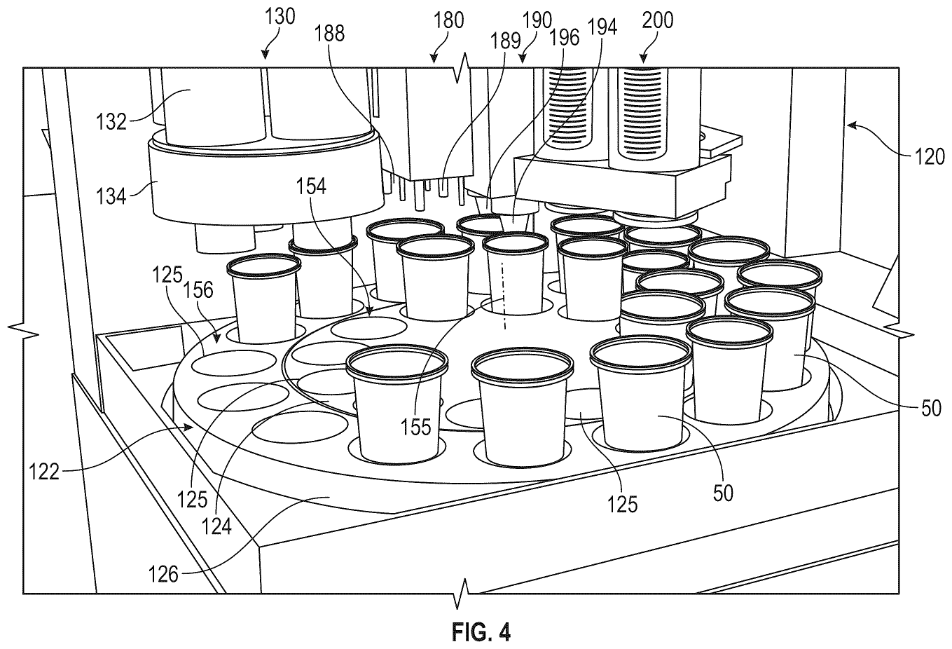

Referring now to FIGS. 4 and 5A, perspective views of the turntable assembly 122 are shown, according to example embodiments. The turntable assembly 122 is shown to include a central axis 155 and a pair of concentric turntables 124, 126. Specifically, turntable assembly 122 includes an inner turntable 124 and an outer turntable 126 disposed circumferentially about the inner turntable 124. The inner turntable 124 may include and define a first or inner row 154 of cup receptacles 125. In the embodiment shown, the outer turntable 126 includes and defines a second or outer row 156 of cup receptacles 125. In other embodiments, the outer turntable 126 is flat (e.g., as shown in FIGS. 2 and 3). Both the inner row 154 and the outer row 156 extend annularly about a central axis 155, with the inner row 154 being disposed radially inward of the outer row 156. In some embodiments, the inner row 154 and the outer row 156 extends circumferentially about the central axis 155 such that the cup receptacles 125 of rows 154, 156 are arranged in concentric circles about axis 155.

Referring specifically to FIG. 5A, the inner turntable 124 and outer turntable 126 are supported by a base plate 149. More particularly, the base plate 149 includes a pair of circumferential rails 147, 148 that support the turntables 124, 126, respectively, via a pair of bearings 144, 146, respectively. The bearings 144, 146 may facilitate rotation of the turntables 124, 126, respectively, about central axis 155 relative to base plate 149 during operation. In some embodiments, bearings 144, 146 may comprise wheels, sliding surfaces, and/or other suitable components or features to facilitate movement (e.g., rotation) of the turntables 124, 126 relative to base plate 149. In other embodiments, the inner turntable 124 may be supported by a shaft (not shown) and the outer turntable 126 is supported along an outer diameter of the outer turntable 126 by a support structure (not shown) of the beverage production system 100.

Inner turntable 124 and outer turntable 126 are received within an outer housing 140 that is in turn mounted on base plate 149 to conceal the circumferential rails 147, 148, and bearings 144, 146. A gearbox 142 is mounted to outer housing 140 that includes one or more gears (not shown) that mesh with gear teeth or other suitable structures formed on outer turntable 126. In other embodiments, either or both the outer turntable 126 and inner turntables 124 may be driven by a rubber wheel (not shown) frictionally engaged on an outside or with other portions of the turntables 124 and/or 126.

A first driver 141 and a second driver 143 are supported in a housing 145 that is coupled to base plate 149 on a side that is opposite from the turntables 124, 126 and outer housing 140. However, in other embodiments (not shown), the second driver 143 may be mounted on the same side as the as the turntables 124, 126. In the present embodiment, an output shaft of the first driver 141 extends through a first aperture 150 in the base plate 149 to couple with the inner turntable 124, and an output shaft of the second driver 143 extends through a second aperture 152 in base plate 149 to engage with the gears within the gearbox 142. In some embodiments, the drivers 141, 143 may comprise electric motors; however, in other embodiments, the drivers 141, 143 may comprise pneumatic motors, hydraulic motors, etc.

During operation, the drivers 141, 143 rotate the turntables 124, 126 about the central axis 155. In particular, the first driver 141 may rotate the inner turntable 124 about axis 155; and the second driver 143 rotates the outer turntable 126 about axis 155 via the gears (not shown) within the gearbox 142. Referring back to FIGS. 1 and 2, the rotation of the turntables 124, 126 about axis 155 may selectively progress cups 50 dispensed by the cup dispensing station 130 through the stations 180, 190, 200 within beverage handling assembly 120 to assemble a beverage order. Because the turntables 124, 126 are rotated about axis 155 via separate drivers (e.g., drivers 141, 143 shown in FIG. 5A), the turntables 124, 126 may be rotated about axis 155 independently from one another about axis 155 during operation. Advantageously, independent rotation of turntables 124, 126 may provide redundancy to beverage production system 100 in case of failure of one or more components thereof. In addition, independent rotation of the turntables 124, 126 may allow beverage production to be subdivided and organized via rows 154, 156. For instance, the rows 154, 156 may be arranged to produce beverages for different sources (e.g., drive-through orders vs. dine-in orders), and/or may be used to produce different beverage types (e.g., carbonated vs. non-carbonated, hot vs. cold). Further details of embodiments of the stations 130, 180, 190, 200 are described below.

Although FIGS. 4 and 5A only illustrates the turntable assembly 122 of FIG. 1, it should be understood that the beverage production system 100 can utilize any of the turntable assemblies shown herein (e.g., the turntable assembly 122, the turntable assembly 222, etc.). As such, the systems and methods described herein may be applicable with a beverage production system 100 comprising any of these turntable assemblies.

Referring to FIG. 5B, a slide assembly 530 configured to push cups between the inner and outer turntables 124, 126 is shown, according to an example embodiment. The slide assembly 530 may be positioned below the turntable assembly 122, 222 or within the inner turntable 124, 224. The slide assembly includes an arm 532 that may be actuated to extend through an opening between the inner turntable 124, 224 and the outer turntable 126, 226. By way of example, the slide assembly 530 may move a cup 50 from a position in the inner row 154, 254 of cup receptacles 125 to the into the aligned portion of the outer turntable 224, 226 (e.g., onto the row 156 of cup receptacles 125, onto the flat surface of the outer turntable 226, etc.). Once cups 50 are filled with beverages by the beverage dispensing station 190 and are lidded by the lidding and printing assembly 200, the cups 50 are pushed from the inner row 154, 254 of cup receptacles 125 to the outer row 156 of cup receptacles 125. As discussed above, in some embodiments, the outer turntable 226 is a flat dial. In such an embodiment, the slide assembly 530 may move a cup 50 from a position within the inner row 254 of cup receptacles 225 directly onto the outer turntable 226 through an opening in the inner turntable 224.

The slide assembly 530 includes an arm 532, a rail 534, a motor 536, and a belt drive 538. The arm 532 includes a portion 533 shaped to engage a curved side of cup 50. The arm 532 is slideably mounted to the rail 534 and connected to the belt drive 538. In an example embodiment, the motor 536 is an electric motor, however in other embodiments, the motor 536 may comprise pneumatic motors, hydraulic motors, etc. The motor 536 is coupled to the belt drive 538 and, when actuated, drives the belt drive 538. This causes the arm 532 to translate along the rail 534 and to move the cup 50 as discussed above. The motor 536 may be coupled to the controller 300 and/or other systems that operate in concert to rotate the turntables to bring the opening in the inner turntable 124, 224 and/or outer turntable 126, 226 into alignment with the arm 532 for sliding cups, from the outer to the inner row of cup receptacles 125 or vice versa. In other embodiments, the slide assembly 530 may include a shaft (e.g., the arm 532) driven to translate horizontally by the motor 536 to push a cup between the inner turntable 124, 224 and the outer turntable 126, 226.

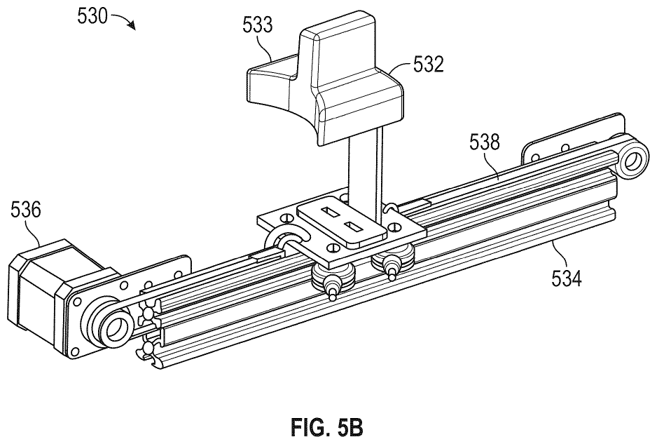

Referring now to FIG. 6, a perspective view of an upper portion of the cup dispensing station 130 is shown, according to example embodiments. In some embodiments, the cup dispensing station 130 includes a central axis 135, a cup dispenser 134, and a plurality of tubular magazines 132 coupled to and extending axially from the cup dispenser 134 with respect to the axis 135. Each magazine 132 includes a first or upper end 132a and a second or lower end 132b, opposite the upper end 132a. The lower end 132b is coupled to a corresponding receptacle 136 in the cup dispenser 134, and the upper end 132a is axially projected away from the cup dispenser 134. Each magazine 132 may receive and store a plurality of cups 50 positioned in a nested relationship (i.e., stacked). In some embodiments, the cups 50 are loaded into the magazines 132 from the upper end 132a. In some embodiments, the magazines 132 may be de-coupled from the cup dispenser 134 to facilitate loading of cups 50 therein. In some embodiments, the tubular magazines 132 include a side opening to receive cups such that the cups may be loaded from the side instead of the top or bottom. The outer configuration of the plurality of tubular magazines 132 may be shapes other than the rounded shape shown (e.g., square, hexagonal, octagonal, etc.).

The cup dispenser 134 is a generally cylindrical member that includes a first or upper side 134a, a second or lower side 134b opposite the upper side 134a, and a cylindrical outer surface 134c extending axially between the sides 134a, 134b. The receptacles 136 extend axially through the cup dispenser 134 between the sides 134a, 134b with respect to the axis 135. The magazines 132 are engaged within the receptacles 136 on the upper side 134a, such that during operation, the cups 50 that are dispensed from the magazines 132 move through the receptacle 136 and are ejected from the lower side 134b.

The cup dispenser 134 is positioned within a housing 131. During operation, the cup dispenser 134 may rotate within the housing 131 about the axis 135. A bearing 139 may be inserted within the housing 131 to engage with the lower side 134b of the cup dispenser 134 and therefore facilitate the rotation of the cup dispenser 134 about the axis 135 during operation. A driver 138 may be coupled to one or more gears 133 positioned within a gearbox 129 of the housing 131. In some embodiments, the driver 138 comprises an electric motor; however, in other embodiments, the driver 138 may comprise a pneumatic motor, a hydraulic motor, or the like. The one or more gears 133 may be coupled (e.g., meshed) with gear teeth or other suitable structures on the cylindrical outer surface 134c of the cup dispenser 134. A top plate 137 may cover the gearbox 129 and the driver 138 may be supported on top plate 137. In other embodiments, the cup dispenser 134 may be driven by a timing belt pulley (not shown) engaged with a top portion of the cup dispenser 134.

Referring still to FIG. 6, during operation, the driver 138 may rotate the cup dispenser 134 about the axis 135 via the one or more gears 133. Specifically, the driver 138 may rotate the cup dispenser 134 to align one or more of the magazines 132 with the receptacles 136 in the cup dispenser 134 with the rows 154, 156 of the cup receptacles 125 on the turntable assembly 122. In some embodiments, the magazines 132 may hold different sizes and/or types of cups that may be selectively aligned with the rows 154, 156 to produce various beverage orders during operation.

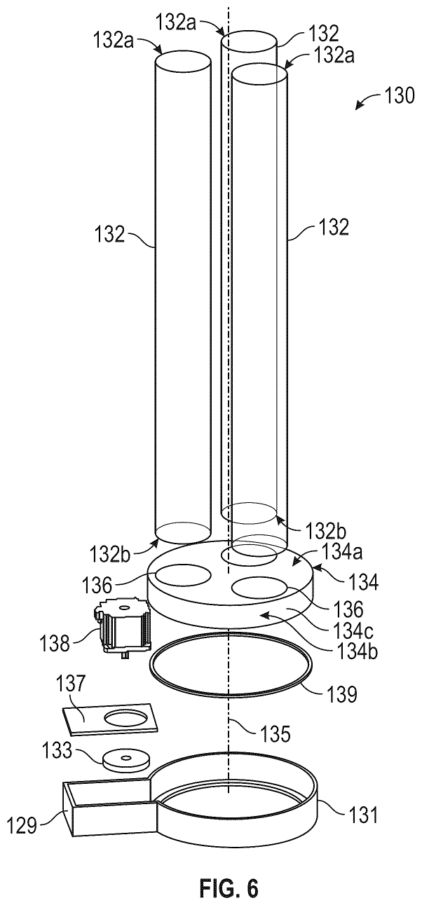

Referring now to FIG. 7, a perspective view of a lower portion of the cup dispensing station 130 is shown, according to example embodiments. In some embodiments the cup dispenser 134 includes an outer housing 163 that defines an internal chamber 167. A cap 160 may be fitted to the housing 163 to close off the internal chamber 167 and to conceal the components disposed therein (described in more detail below). The cap 160 may define an upper side 134a, and the housing 163 may define a lower side 134b. The housing 163 may also form the cylindrical outer surface 134c of the cup dispenser 134.

A plurality of ring gears 166 are disposed within the internal chamber 167 and aligned with each of the receptacles 136 along a corresponding axis 165. A driving gear 168 is engaged (e.g., meshed) with gear teeth or other suitable structures on a radially outer surface of each of the ring gears 166. The driving gears 168 are coupled to the drivers 162. The drivers 162 and the driving gears 168 may be mounted to cap 160. By way of example, the driving gears 168 may be engaged with output shafts (not shown) of the drivers 162 that extend through suitable apertures (not shown) in cap 160. During operation, the drivers 162 may rotate the driving gears 168 to thereby drive rotation of the ring gears 166 about the corresponding axes 165. Bearings 169 may be installed within the internal chamber 167 to facilitate and support the rotation of the ring gears 166 about the axes 165. In some embodiments, the drivers 162 comprise electric motors; however, in other embodiments, the drivers 162 may comprise pneumatic motors, hydraulic motors, etc.

Each axis 165 is parallel to and radially offset from the central axis 135. In some embodiments, the axes 165 are evenly spaced circumferentially about the axis 135. In the embodiment of the cup dispensing station 130 shown in FIGS. 4 and 5A, there are a total of three magazines 132 and, therefore, three receptacles 136. As a result, the axes 165 are circumferentially spaced approximately 120° from one another about the axis 135. In other embodiments, more or fewer than three magazines 132 may be included to accommodate a desired number of cup sizes or types.

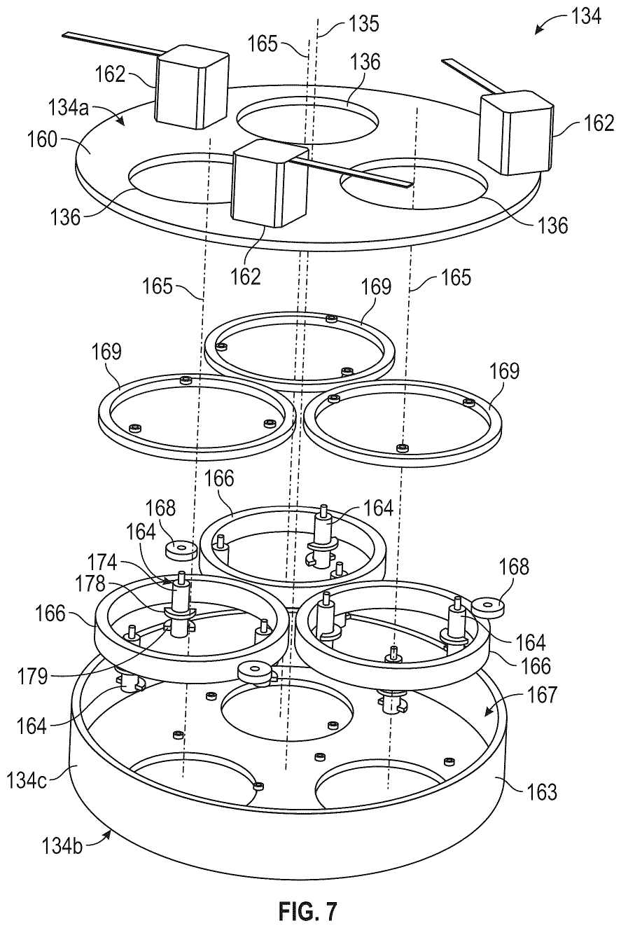

Referring specifically now to FIG. 8, each cup dispenser 134 includes the central axis 135, the first or upper side 134a and the second or lower side 134b opposite the upper side 134a. A receptacle 136 extends axially through the cup dispenser 134 between the sides 134a, 134b with respect to the axis 135. The corresponding magazine 132 is engaged within the receptacles 136 on the upper side 134a and extends away from the upper side 134a along the axis 135. During operation, the cups 50 that are dispensed from the magazines 132 move through the receptacle 136 and are ejected from the lower side 134b.

The cup dispenser 134 has an internal chamber 167 that the cups 50 may enter and exit through via the receptacle 136. The ring gear 166 is disposed within the internal chamber 167 and aligned with the receptacle 136 along the axis 135. The driving gear 168 is engaged (e.g., meshed) with gear teeth or other suitable structures on a radial outer surface of each of the ring gear 166. The driving gear 168 is coupled to the driver 162 that may be mounted within the internal chamber 167. During operation, the driver 162 may rotate the driving gear 168 to thereby drive rotation of the ring gear 166 about the axis 135. In some embodiments, the driver 162 comprises an electric motor; however, in other embodiments, the driver 162 may comprise a pneumatic motor, a hydraulic motor, etc. A plurality of de-nesting assemblies 164 are positioned within the ring gear 166, each de-nesting assembly 164 includes a cylindrical body 174 including a central or longitudinal axis.

For example, the de-nesting assembly may include a monitoring system that determines whether cups 50 are not being properly de-nested (e.g., due to cup jams, two or more cups being stuck together, varied cup sizes in a single cup stack, etc.). For example, a current sensor may be positioned between the power source (e.g., a wall outlet, a battery, etc.) and the driver 162 (e.g., the motor driving the assembly). The current sensor detects and monitors the current flowing to the motor and transmits this information to the controller 300. If the current spikes beyond a predefined threshold—indicative of a potential stall condition (e.g., due to cups sticking together)—the controller 300 may operate the cup dispensing station 130 to take corrective action (e.g., ceasing operation of the driver 162 to stop de-nesting cups). In some examples, the de-nesting assembly 164 includes a circuit breaker disposed between the power source and the driver 162 that shuts off power to the driver 162 if the current spikes beyond the predefined threshold.

In some examples, a temperature sensor may be integrated into the de-nesting assembly 164 to monitor the temperature of the driver 162 and surrounding components (e.g., the driving gear 168). A rotational speed sensor (e.g., a Hall effect sensor, a rotary sensor, gyroscopes, etc.) may also be included to measure the rotations per minute (RPM) of the driver(s) 162. Such data may be transmitted to the controller 300 and compared to a predetermined threshold. This concept is explored in greater detail with regards to FIG. 15.

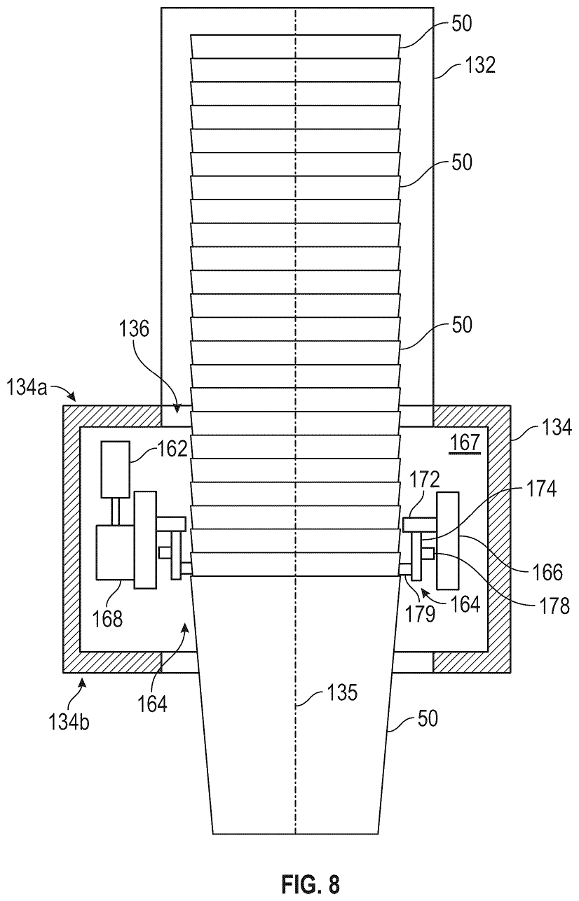

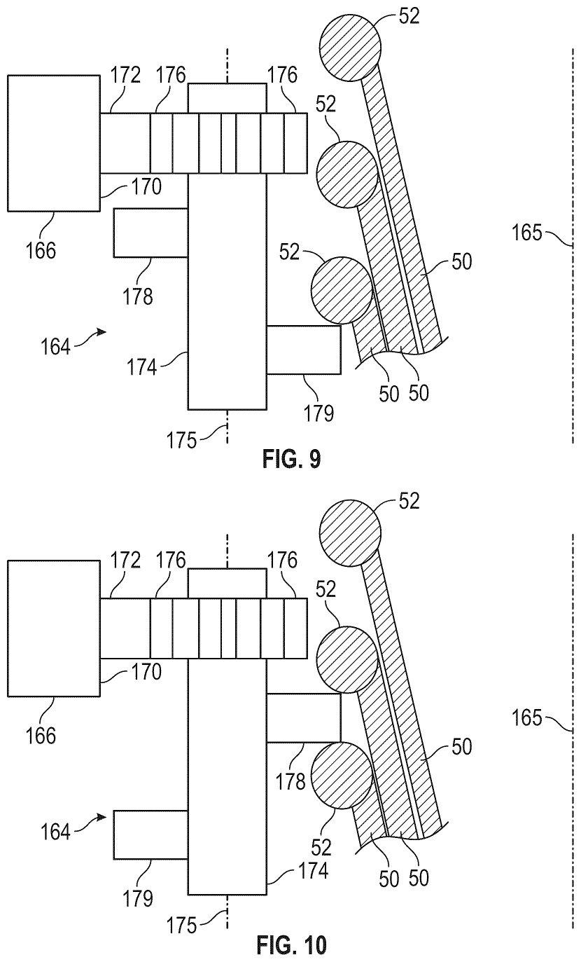

Referring now to FIGS. 9 and 10, a schematic diagram of the de-nesting assembly 164 is shown, according to an example embodiment. Each de-nesting assembly 164 includes a cylindrical body 174 including a central or longitudinal axis 175. Within each ring gear 166, the axes 175 of the de-nesting assembly 164 may be parallel to and radially offset from the axis 165. The body 174 includes a plurality of gear teeth 176 that extend circumferentially about axis 175. The teeth 176 may engage (e.g., mesh) with the corresponding teeth 172 on the radially inner surface 170 of the ring gears 166. Accordingly, the rotation of the ring gears 166 about the axes 165 results in rotation of the de-nesting assembly 164 about the axes 175 via engagement of the teeth 172, 176.

A pair of wedges 178, 179 extend radially outward from the body 174. The wedges 178, 179 may extend radially outward from radially opposite sides of the body 174 with respect to the axis 175. In some embodiments, the wedges 178, 179 may extend circumferentially approximately 180° about the body 174; however, wedges 178, 179 may extend circumferentially extend more or less than 180° about body 174, in some embodiments. In addition, the wedges 178, 179 are axially spaced from one another such that the wedge 178 may be positioned axially above the wedge 179 along the axis 175. Accordingly, the wedge 178 may be referred to herein as a first or upper wedge 178 and the wedge 179 may be referred to herein as a second or lower wedge 179.

During operation, the de-nesting assembly 164 may rotate about the axes 175 so as to engage the wedges 178, 179 with the cups 50 extending into the receptacles 136 of the cup dispenser 134. The upper wedge 178 may engage between axially adjacent cups 50 to dislodge cups 50 from the cup dispenser 134 when desired, and the lower wedges 179 may support the cups 50 within the cup dispenser 134 when a cup 50 is not to be dispensed therefrom. In particular, during operation, each de-nesting assembly 164 may be transitioned between a first position shown in FIG. 9 and a second position shown in FIG. 10 in order to selectively dislodge and dispense cups 50 from the cup dispenser 134. In the first position (FIG. 9), the lower wedge 179 may be circumferentially rotated about the axis 175 so as to extend radially inward toward the axis 165 and therefore the cups 50. As a result, the lower wedge 179 of each de-nesting assembly 164 may engage with the lip 52 of the lowest cup 50 within the cup dispenser 134 to prevent cups 50 from falling through the cup dispenser 134 when de-nesting assemblies 164 are in the first position (FIG. 9). In example embodiments, the de-nesting assembly 164 includes one or more real or virtual sensors communicatively coupled with a controller (e.g., the controller 300 of FIG. 15). In other embodiments, the drivers 162 are communicatively coupled with the controller (e.g., the controller 300 of FIG. 15). The sensors and/or the drivers 162 may acquire data associated with the operation of the de-nesting assembly 164 (e.g., current draw, power consumption, temperature, rotations per minute (RPM), etc.).

When dispensing a cup 50 from the cup dispenser 134, the de-nesting assembly 164 may be transitioned from the first position (FIG. 9) to the second position (FIG. 10) by rotating the bodies 174 about the axes 175 to thereby engage the upper wedges 178 between the lips 52 of the two lowest cups 50 within the cup dispenser 134. The upper wedges 178 may comprise axial widths (e.g., with respect to the axes 175) that axially taper when moving circumferentially about the body 174 so that as the body 174 rotates about the axis 175 from the first position (FIG. 6) to the second position (FIG. 7), the lips 52 of the adjacent cups 50 are gradually forced apart along the axis 165, until the contact between the adjacent cups 50 is reduced to a point that the axially lowermost cup 50 may fall through the receptacle 136 and into a cup receptacle 125 in one of the rows 154, 156 on turntable assembly 122 shown in FIGS. 1 and 2. When in the second position (FIG. 10), the un-dispensed cups 50 within the cup dispenser 134 may be supported by the upper wedges 178.

Once the lowermost cup 50 has been dispensed from the cup dispenser 134, the de-nesting assemblies 164 may then be again transitioned from the second position (FIG. 10) back to the first position (FIG. 9) by rotating the bodies 174 about the axes 175 to thereby re-align the lower wedges 179 within the cups 50. As the bodies 174 are rotated about the axes 175 from the second position (FIG. 10) to the first position (FIG. 9), the cups 50 may fall downward along the axis 165 so that the lip 52 of the lowest cup 50 within the cup dispenser 134 engages with the lower wedges 179 as before. Accordingly, once the de-nesting assemblies 164 return to the first position (FIG. 9), the cup dispenser 134 is once again ready to dispense another cup 50 in the manner described above. In some embodiments, the de-nesting assemblies 164 may be transitioned from the first position (FIG. 9) to the second position (FIG. 10) and back to the first position (FIG. 9) via a continuous rotation of the bodies 174 about the axes 175 (e.g., a full 360° about the axes 175).

While some particular examples of the cup dispensing station 130 have been described above, it should be appreciated that various features of the cup dispensing station 130 may be altered, replaced, or removed in various embodiments, and that some embodiments of the cup dispensing station 130 may include additional features.

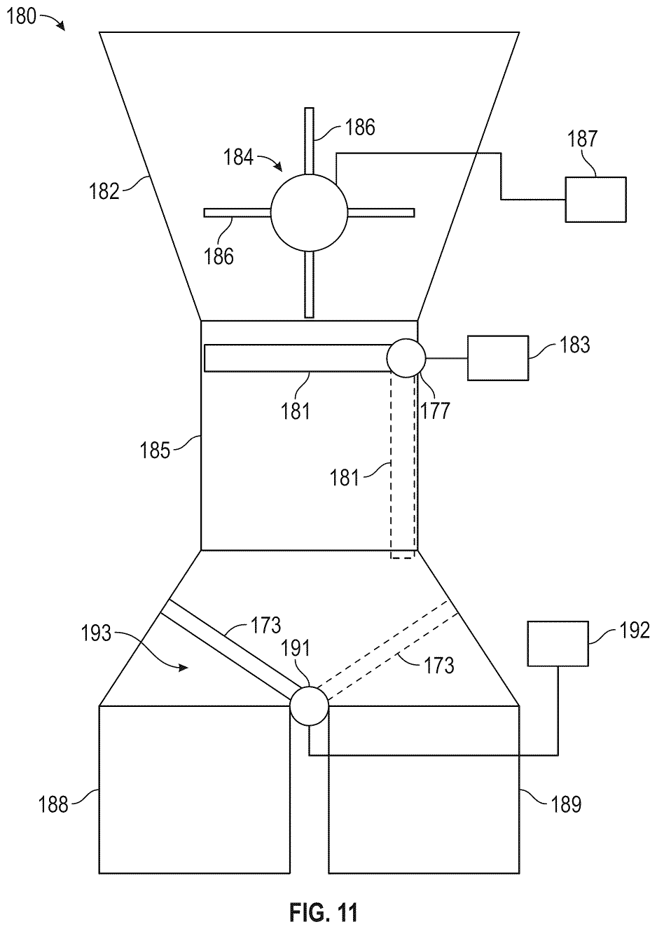

Referring now to FIG. 11, a schematic diagram of the ice dispensing station 180 is shown, according to example embodiments. In some embodiments the ice dispensing station 180 includes an inlet 182, a pair of outlets 188, 189, and a chute 185 positioned between the inlet 182 and the outlets 188, 189. The outlet 188 may be aligned with the inner row 154 of the cup receptacles 125 (shown in FIG. 4), and the outlet 189 may be aligned with the outer row 156 of cup receptacles 125 (shown in FIG. 4).

The inlet 182 may be coupled to or may comprise part or all of the ice chamber 112 shown in FIG. 1. An agitator 184 is disposed within the inlet 182. The agitator 184 includes a plurality of paddles 186 that are driven to rotate within the inlet 182 by a driver 187. The engagement between the paddles 186 and ice within the inlet 182 breaks up ice blockages therein and helps to ensure the continued progression of ice through the inlet 182 and into the chute 185.

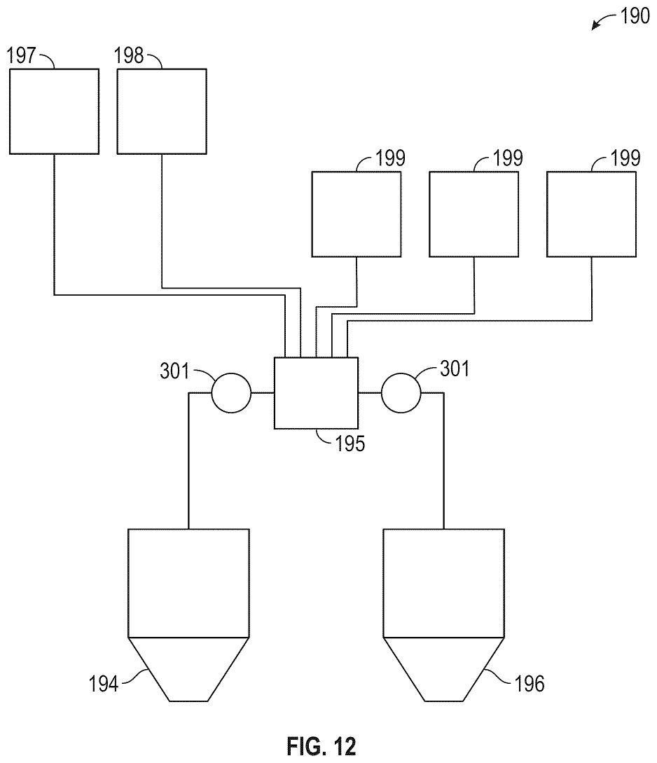

A dispensing valve 181 is positioned within the chute 185. The dispensing valve 181 may generally comprise a gate valve that is transitionable between a first or closed position (shown in solid line in FIG. 12) to block progression of ice through the chute 185 toward the outlets 188, 189 and a second or open position (shown in dotted line in FIG. 12) to allow ice to progress through the chute 185 toward the outlets 188, 189. In some embodiments, a driver 183 may actuate the dispensing valve 181 between the closed position and the open position by pivoting the dispensing valve 181 about a hinge 177. In some embodiments, the dispensing valve 181 may translate into and out of the chute 185 in a direction that is generally perpendicular to the flow or movement of ice within the chute 185 during operation.

In some embodiments, an outlet selection valve 193 is coupled to the outlets 188, 189. The outlet selection valve 193 may comprise a gate 173 that is pivotable about a hinge 191 to selectively block one of the outlets 188, 189. In particular, a driver 192 may pivot the gate 173 about the hinge 191 to a first position (shown in solid line in FIG. 11) to block the outlet 188 so that ice progressing out of the chute 185 is directed into the outlet 189. In addition, the driver 192 may pivot the gate 173 about the hinge 191 to a second position (shown in dotted line in FIG. 11) to block outlet 189 so that ice progressing out of the chute 185 is directed into the outlet 188.

The outlets 188, 189 may be aligned with the rows 154, 156. Thus, during operation, when ice is to be dispensed into a cup 50 positioned within an aligned cup receptacle 125, the driver 183 may transition the dispensing valve 181 to the open position, allowing ice progress through the chute 185 under the force of gravity. Depending on whether the cup to receive the ice is positioned in a cup receptacle 125 of the inner row 154 or the outer row 156, the driver 192 may pivot the gate 173 of outlet selection valve 193 to the first or second position to direct ice out of the desired corresponding outlet 188, 189. During these operations, the driver 187 may rotate the paddles 186 of the agitator 184 within the inlet 182 to ensure the continued progression of the ice toward chute 185.

In some embodiments, the outlet selection valve 193 may be replaced with a pair of valve or gate assemblies that are coupled to the outlets 188, 189. Accordingly, in these embodiments, ice may be dispensed out of one or both of the outlets 188, 189 by actuating the gate assemblies (not shown) for the selected outlet(s) 188, 189 during operation.

The valves (e.g., valves 181, 193, etc.) may be actuated to dispense ice out of an outlet 188, 189 for a specified period of time to prevent overfilling. In some embodiments, suitable sensors or other measurement devices may be included within the ice dispensing station 180 to monitor the volume of ice that is dispensed from the outlets 188, 189 to prevent overfilling. In some embodiments, a weight or force sensor may be employed (e.g., within the cup receptacles 125 in FIGS. 1 and 2) to monitor the combined weight of the cup and dispensed ice to prevent overfilling. In these various embodiments, the amount of ice to be dispensed (and therefore the various parameters for monitoring the amount of dispensed ice) may depend upon the size of the cup 50 aligned with the ice dispensing station 180.

In some embodiments, the drivers 187, 183, 192 may comprise electric motors. However, the drivers 187, 183, 192 may comprise any suitable driving device such as, for instance, pneumatic motors, hydraulic motors, or the like.

In other embodiments, instead of a pair of outlets 188, 189, the ice dispensing station 180 may include only one outlet, such as either outlet 188 or 189, and dispense ice into cups 50 in only one of the rows, such as either the outer or inner row 154 or 156. For example, in this embodiment (not shown), outlet 189 may be omitted as would driver 192 and the pivot gate 173. Also in this embodiment, the agitator 184 and the paddles 186 may be replaced with an auger or other element in communication with timing circuitry to operate for a specified duration to dispense the appropriate amount of ice into the cups 50. This embodiment is intended for variations of the beverage production system 100 that provide for beverage filling on only one of the inner row 154 or the outer row 156, instead of beverage filling on both of the rows 154 and 156.

After ice is dispensed into the cups 50 at the ice dispensing station 180, the turntables 124, 126 may rotate about axis 155 to align the cups 50 with the beverage dispensing station 190. The beverage dispensing station 190 includes a pair of nozzles 194, 196. In some examples, a first nozzle 194 being aligned with the inner row 154 of the cup receptacles 125, and a second nozzle 196 being aligned with the outer row 156 of the cup receptacles 125. In other examples, the first nozzle 194 and second nozzle 196 are both aligned with the inner row 154, 254 In such an example, the first nozzle 194 may be positioned upstream from the second nozzle 196. During operation, the nozzles 194, 196 may dispense a selected beverage into the cups 50 disposed in the rows 154, 254, 156.

Referring to FIG. 12, a schematic diagram of the beverage dispensing station 190 is shown, according to an example embodiment. In some embodiments each of the nozzles 194, 196 may be coupled to a distribution valve assembly 195. In turn, the distribution valve assembly 195 may be coupled to a carbonated water source 197, a non-carbonated water source 198, and a plurality of flavoring sources 199. Additional valving, pumps, and other components may be included to facilitate and control the flow of fluid from the sources 197, 198, 199. During operation, when a cup (e.g., cup 50 in FIGS. 1 and 2) is aligned with one of the nozzles 194, 196, a selected beverage is dispensed by flowing water from one (or both) of the sources 197, 198, and flowing flavoring from one or more of the sources 199 to the distribution valve assembly 195. Thereafter, the distribution valve assembly 195 may actuate to route the fluids to the selected nozzle 194, 196. The fluids may mix within the distribution valve assembly 195, the nozzle(s) 194, 196, and/or therebetween to form the selected beverage. In other embodiments, additional fluid sources may be connected to the distribution valve assembly 195 for dispensing beverages that do not require mixing, including, but not limited to, juice, coffee, and milk.

The beverage dispensing station 190 is shown to include sensors 301. In example embodiments, the sensors 301 are ultrasonic sensors that receive or detect an indication of (e.g., measure) a fill level of the cup 50 after at least one of the first nozzle 194 or the second nozzle 196 dispense a beverage volume into the cup 50. In one embodiment, a first ultrasonic sensor is positioned proximate the first nozzle 194 to determine a fill level of beverage dispensed by the first nozzle 194. In another embodiment, an ultrasonic sensor is positioned proximate the second nozzle 196 to determine a fill level of beverage dispensed by the first and second nozzles 194 and 196. In yet another embodiment, two or more ultrasonic sensors are provided to determine the fill level of the beverage dispensed by each of the nozzles 194 and 196. In the example shown, at least one ultrasonic sensor is positioned between the first nozzle 194 and the second nozzle 196, and the at least one ultrasonic sensor determines how much liquid (a fill level) is in the cup after the first nozzle 194 dispenses the liquid. In operation, the at least one ultrasonic sensor may measure a height of ice in the cup, a height of the first fill amount from first nozzle 194, or some combination thereof in order to determine how much liquid has been dispensed into the cup from the first nozzle 194. This information may be used by the controller 300 to control a dispense amount of liquid from the second nozzle 196 to top off the cup with liquid. It should be understood that in other embodiments, a different sensor type may be utilized with the automatic beverage dispenser. The sensors 301 may be communicatively coupled with a controller (e.g., the controller 300 of FIG. 15).

Additionally or alternatively, the distribution valve assembly 195 may include or be coupled to a timer to ensure or attempt to ensure that the correct amounts of fluids are dispensed from the selected nozzle 194, 196 to preventing overfilling. In some embodiments, the distribution valve assembly 195 may additionally or alternatively monitor a volume of dispensed fluids to and from the nozzles 194, 196 (e.g., via flow rate sensors, pressure sensors, etc.) to prevent overfilling. In some embodiments, a weight or force sensor may be employed (e.g., within the cup receptacles 125 in FIGS. 1 and 2) to monitor the combined weight of the cup, ice (if any), and dispensed beverage to prevent or attempt to prevent overfilling. In this way, the controller 300 may be programmed with predefined weight thresholds for each cup size (which may further be a function of chosen beverages to account for varying density beverages). If the detected weight from a weight sensor(s) reaches the predefined weight threshold, the controller 300 may send a command to the nozzle 194 and/or 196 to cease dispensing beverage to prevent or attempt to prevent an overfill occurrence. In these various embodiments, the amount of fluid to be dispensed (and therefore the various parameters for monitoring the amount of dispensed fluid) may depend upon the size of cup 50 aligned with the beverage dispensing station 190.

While the embodiment of beverage dispensing station 190 shown in FIG. 12 includes two nozzles 194, 196, it should be appreciated that different numbers and arrangements of nozzles may be utilized in other embodiments. For instance, referring again to FIGS. 1 and 2, in some embodiments, the beverage dispensing station 190 may include a plurality of nozzles for dispensing beverages into the cups 50 disposed in the inner row 154 and/or a plurality of nozzles for dispensing beverages into the cups 50 disposed in the outer row 156. The number and arrangement of the nozzles (e.g., nozzles 194, 196) of the beverage dispensing station 190 may allow specific beverages or groups of beverages to be dispensed from selected nozzles and may increase the number of beverages that may be dispensed into the cups 50 over a period of time. In addition, the nozzles of the beverage dispensing station 190 (e.g., nozzles 194, 196) may be separately coupled to the sources 197, 198, 199 so that beverages may be dispensed simultaneously from the various nozzles during operation. In embodiments where beverages are filled on only one of the inner or outers rows 154, 156 of cup receptacles, only one of the nozzles 194, 196 may be present. In this way, the number and location of beverage dispensing nozzles (and ice dispensing chutes) may differ in other embodiments (e.g., three or more nozzles and two or more ice dispensing chutes, etc.).

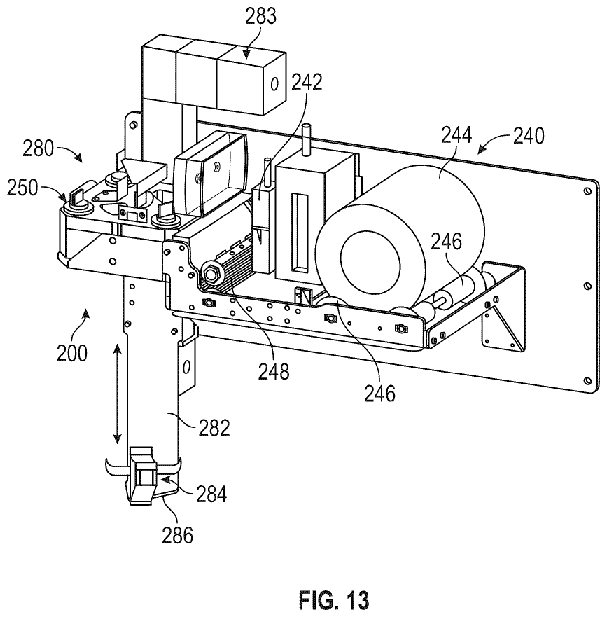

Referring to FIG. 13, a perspective view of the lidding and printing assembly 200 is shown, according to an example embodiment. The lidding and printing assembly 200 includes sealing film 244, an in-line printer 240, and a piercer 242. The sealing film 244 may be provided in a roll (as shown) and positioned on a series of rollers 246. The sealing film 244 may be fed into one or more motor/rollers 248 such that when the sealing film 244 is drawn by the one or more motor/rollers 248, the roll of sealing film 244 unrolls and extends above the cup 50 into position for sealing as a lid. The in-line printer 240 prints beverage identifying indicia on the upper or top side of the sealing film 244 such that it is visible to the server or customer. The beverage identifying indicia may identify the type and size of the beverage, associated order number, customer name, destination identification (ID), or other any other useful or identifying information.

The piercer 242 may puncture a hole, score, or make various indentions in the sealing film 244 to promote introduction of, for example but not limited to, a drinking straw through the sealing film 244. Sealer bulbs 250 are positioned above the sealing film 244 and the cup 50 lip 52 or rim. The sealer bulbs 250 may then be electrified to generate heat to heat seal the sealing film 244 about the lip 52 or rim of the cup 50. The sealing film 244 may then be separated, such as but not limited to, by cutting the sealing film 244 or tearing along perforated or scored sections of the sealing film 244. The present disclosure also contemplates that the process of printing, piercing, and heat sealing may occur in other orders in other embodiments.

The lidding and printing assembly 200 is shown to include a lift assembly 280. The lift assembly 280 operates to lift the cup 50 vertically from a seated position in the outer row 156 of cup receptacles 125 to bring the lip 52 or rim of the cup 50 into position below the lidding and printing assembly 200 for lidding the cup 50. The lift assembly 280 includes a linear actuator 282 and a cup centering device 284. The cup centering device 284 is coupled to an elbow 286 that extends from the bottom of the linear actuator 282. A belt driven motor (not shown) drives the linear actuator 282 vertically up and down perpendicular to a plane parallel with the surface of the turntable assembly 122. The belt driven motor (not shown) may be electric, hydraulic, pneumatic, etc. A plunger and limit switch 283 is configured to determine when the linear actuator 282 has sufficiently raised the cup 50 into position for lidding. When the lidding and printing process is complete, the linear actuator 282 lowers the cup 50 back into position in the inner turntable 124 and/or the outer turntable 126. In some embodiments, all or portions of the lidding and printing assembly 200 may be positioned above the cup 50 and moved vertically downward toward the cup 50 for lidding the cup 50 while the cup 50 remains stationary in the inner turntable 124 and/or the outer turntable 126.

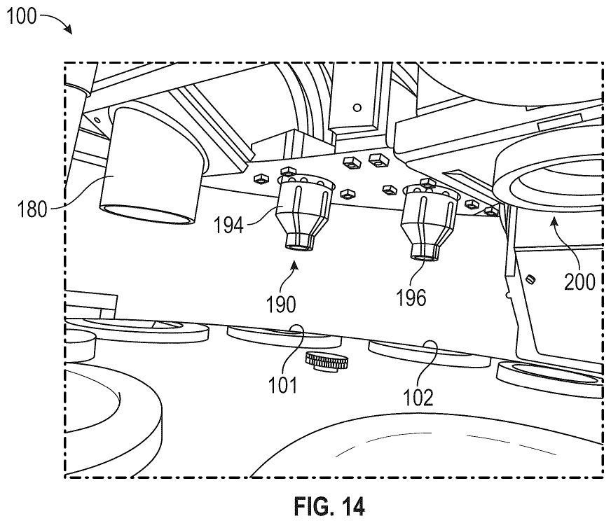

FIG. 14, illustrates locations of the ice dispensing station 180, the beverage dispensing station 190, and the lidding and printing assembly 200, according to one embodiment. A portion of the beverage production system 100 is shown in more detail. As can be seen, as the inner turntable 124 rotates clockwise, cups 50 are dispensed into the cup receptacles 125, a cup 50 is positioned under the ice dispensing station 180 for dispensing ice into the cup 50, then to the beverage dispensing station 190 for dispensing beverages into the cup 50, and then to the lidding and printing assembly 200 for lidding the cup 50 and providing identifying indicia on the lid.

In this embodiment, the beverage dispensing station 190 includes two (2) nozzles 194, 196 for dispensing beverages, although other numbers of nozzles are contemplated. In this embodiment, the first nozzle 194 may be used to substantially fill the cup 50 with a beverage at a first location 101, while the second nozzle 196 may be used to top-off or complete filling of the beverage at a second location 102. It may be useful to provide two beverage fill locations to completely fill the cup 50 with the desired beverage. However, in other embodiments, the first and second nozzles 194, 196 may be used to dispense different types of beverages, to provide redundancy, or to increase the production or number of beverages that may be filled.

Once the beverage filling is completed on the inner turntable 124, the filled cup 50 may be transitioned to the outer turntable 126 via the arm 532. The outer turntable 126 may then be indexed or rotated clockwise one or more cup positions to provide space for the next completed beverage. Advantageously, providing the outer turntable 126 as an outer turntable 126 instead of separate cup receptacles, may provide additional space for a more completed beverage and also allow easier access to the completed beverages.

Operationally, the beverage production system 100 may receive input from the POS or other systems, such as the remote computing system 113 as discussed below. Further, sensors provided at various locations about the beverage production system 100 may be used to control the advancement of the inner and outer turntables 124, 126 to ensure, for example, that completed beverage orders on the outer turntable 126 are accessible to users and, further, do not interfere with the filled and lidded cups 50 transitioning from the inner turntable 124 to the outer turntable 126.

While the beverage production system 100 has been described has having cup receptacles 125 on only the inner turntable 124 and no cup receptacles on the outer turntable 126, it is contemplated that the outer turntable 126 might have one or more cup receptacles 125 and that the inner turntable 124 might have fewer or no cup receptacles 125 in other embodiments. Further, while beverage production is described in this embodiment as being accomplished on the inner turntable 124, it is contemplated that cups 50 might also be filled on the outer turntable 126 instead of or in addition to inner turntable 124. Further, while filled and lidded cups 50 (i.e., completed beverage orders) are described as being transitioned from the inner to the outer turntables 124, 126, completed beverage orders might remain in the inner turntable 124 or might be filled on the outer turntable 126 and transitioned to the inner turntable 124.

Referring now to FIG. 15, a block diagram of a system 15 including the controller 300 is shown, according to example embodiments. The controller 300 may be a part of the automatic beverage dispenser (i.e., the beverage production system 100) as described herein. The beverage production system 100 may be a part of a connected system 15. The system 15 is shown to include the user device 111 and a remote computing system 113 that are each coupled to the beverage production system 100 via a network 10. In some embodiments, the user device 111 may comprise a touch-sensitive electronic display (e.g., a tablet integrated with the beverage production system 100). In other embodiments, the user device 111 may be a remote user computing device relative to the beverage production system 100 and be, for example, a laptop computer, a desktop computer, a mobile device, an Ewon server, etc.

Each of the components of the system 15 are in communication with each other. By way of example, the user device 111 and the remote computing system 113 may be communicatively coupled to the controller 300 by the network 10. In other examples, the user device 111 and the remote computing system 113 are directly communicatively coupled with the controller 300 by a wired or wireless connection. In example embodiments, the remote computing system 113, the controller 300, and/or the user device 111 are communicatively coupled to the network 10 such that the network 10 permits the direct or indirect exchange of data, values, instructions, messages, and the like (represented by the double-headed arrows). In some arrangements, the network 10 is configured to communicatively couple to additional computing system(s), such as the POS system 115 or a local area network (LAN). In some examples, a distributed services switch (e.g., an Aruba switch) that facilitates communication and data transfer between the controller 300 and the POS system 115 is coupled to the controller 300 via wired and/or wireless connection. In operation, the network 10 facilitates communication of data between the remote computing system 113 and other computing systems associated with a service provider, a customer, or business partner of the service provider. The network 10 may include one or more of a cellular network, the Internet, Wi-Fi, Wi-Max, a proprietary provider network, a proprietary service provider network, and/or any other kind of wireless and/or wired network. In some examples, network 10 is communicatively coupled to the controller 300 via a virtual private network (VPN) gateway. The VPN gateway may be connected to the controller 300 through an Ethernet port and may be connected to the network 10 by wired and/or wireless connection. In this way, the VPN gateway provides a secure tunnel between the controller 300 and the network 10, allowing for encrypted data transmission. As an example, a service provider might use the VPN gateway to remotely monitor and control the beverage production system 100, ensuring the security of data such as machine diagnostics, transaction information, and usage statistics. The VPN gateway may encrypt a portion of or all data traveling between the controller 300 and the remote computing system 113, to resist interception or tampering during transit over the network 10 (e.g., when the network is public internet, a public network/Wi-Fi, etc.).

The remote computing system 113 is a remote computing system such as a remote server, a cloud computing system, and the like. Accordingly, as used herein, “remote computing system” and “cloud computing system” are interchangeably used to refer to a computing or data processing system that has terminals distant from the central processing unit (e.g., processing circuit 302) from which users and/or other computing systems communicate with the central processing unit. In some embodiments, the remote computing system 113 is part of a larger computing system such as a multi-purpose server, or other multi-purpose computing system. In other embodiments, the remote computing system 113 is implemented on a third-party computing device operated by a third-party service provider (e.g., AWS, Azure, GCP, and/or other third-party computing services).

The remote computing system 113 is operated by a product and/or service provider associated with the system 15/the beverage production system 100. Accordingly, in some embodiments, the remote computing system 113 is a service and/or system/component provider computing system and in turn is controlled by, managed by, or otherwise associated with a service provider, a system/component provider (e.g., a beverage producer, a beverage production system manufacturer, or provider, etc.). In the example shown, the provider is a provider of the beverage production system 100, such that the provider, via the remote computing system 113, can receive information regarding operation of the beverage production systems 100 that have been distributed/implemented in the field. Further, the provider operating the remote computing system may make updates or changes to configurations of the beverage production system 100 from a remote location and/or otherwise control operation, at least partly, of the beverage production systems 100 in the field.

The controller 300 is shown to include at least one processing circuit 302, one or more specialized processing circuits, and a communications interface 324. The processing circuit 302 may be structured or configured to execute or implement the instructions, commands, and/or control processes described herein with respect to the order parsing circuit 312, the beverage fill circuit 314, the flush circuit 316, the fault detection circuit 318, the fault log 320, and the usage information and supply circuit 322 (i.e., “the specialized processing circuits”).

In one configuration, the specialized processing circuits are embodied as machine-or computer-readable media storing instructions that are executable by a processor, such as the processor 304. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media instructions may include code, which may be written in any programming language including, but not limited to, Java or the like, and any conventional procedural programming languages, such as the “C” programming language or similar programming languages. The computer-readable program code may be executed on one processor or multiple remote processors. In the latter scenario, the remote processors may be connected to each other through any type of network (e.g., CAN bus, etc.).

In another configuration, one or more of the specialized processing circuits are embodied as a hardware unit, such as one or more electronic control units. As such, the specialized processing circuits may be embodied as one or more circuitry components including, but not limited to, processing circuitry, network interfaces, peripheral devices, input devices, output devices, sensors, etc. In some embodiments, the specialized processing circuits may take the form of one or more analog circuits, electronic circuits (e.g., integrated circuits (IC), discrete circuits, system on a chip (SOCs) circuit, microcontrollers, etc.), telecommunication circuits, hybrid circuits, and any other type of “circuit.” In this regard, the specialized processing circuits may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The specialized circuits may also be or include programmable hardware devices, such as field-programmable gate arrays, programmable array logic, programmable logic devices, or the like. The specialized processing circuits may include one or more memory devices storing instructions thereon that are executable by the processor(s) of the specialized processing circuits. The one or more memory devices and processor(s) may have the same definition as provided below with respect to the memory device 306 and the processor 304. In some hardware unit configurations, the specialized processing circuits may be geographically dispersed throughout separate locations in the beverage production system 100. Alternatively, and as shown, the specialized processing circuits may be embodied in/within a single unit/housing, which is shown as the controller 300.

In the example shown, the controller 300 includes the at least one processing circuit 302 having the at least one processor 304 and the at least one memory device 306. The processing circuit 302 may be structured or configured to execute or implement the instructions, commands, and/or control processes described herein with respect to the specialized processing circuits. The depicted configuration represents the specialized processing circuits as being embodied as machine-or computer-readable media storing instructions (which may be stored by the memory device 306). However, as mentioned above, this illustration is not meant to be limiting as the present disclosure contemplates other embodiments where the specialized processing circuit is configured as a hardware unit. All such combinations and variations are intended to fall within the scope of the present disclosure.

The processor 304 may be implemented as one or more single-or multi-chip processors, digital signal processors (DSPs), application specific integrated circuits (ASICs), field-programmable gate arrays (FPGAs), and/or other suitable processors (e.g., programmable logic devices, discrete hardware components, etc., suitable to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the specialized processing circuits may comprise or otherwise share the same processor, which, in some example embodiments, may execute instructions stored or otherwise accessed via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 306 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 306 may include dynamic random-access memory (DRAM). The memory device 306 may be communicably connected to the processor 304 to provide computer code or instructions to the processor 304 for executing at least some of the processes described herein. Moreover, the memory device 306 may be or include tangible, non-transient volatile memory, or non-volatile memory. Accordingly, the memory device 306 may include database components, object code components, script components, or any other type of information structure for supporting the various activities and information structures described herein. As shown in FIG. 15, the memory device 306 may store various settings associated with the system 15. For example, the memory device 306 may store device configuration settings 308, and network configuration settings 310.

The communications interface 324 may include any combination of wired and/or wireless interfaces (e.g., jacks, antennas, transmitters, receivers, transceivers, wire terminals) for conducting data communications with various systems, devices, or networks structured to enable communications between and among the components of the beverage production system 100 and remote communications (e.g., with the remote computing system 113, with the network 10, etc.). For example, and regarding the remote communications, the communications interface 324 may include an Ethernet card and port for sending and receiving data via an Ethernet-based communications network and/or a Wi-Fi transceiver for communicating via a wireless communications network. The communications interface 324 may be structured to communicate via local area networks or wide area networks (e.g., the Internet) and may use a variety of communications protocols (e.g., IP, LON, Bluetooth, ZigBee, radio, cellular, near field communication).

Referring still to FIG. 15, the controller 300 is shown to include device configuration settings 308 stored on the memory 306. The device configuration settings 308 may include programmable features/settings associated with the various devices controlled by the controller 300 such as the turntable assembly 122, 222, the cup dispensing station 130, the ice dispensing station 180, the beverage dispensing station 190, the lidding and printing assembly 200, etc. For example, the device configuration settings 308 may include increments of rotation, default rotation speeds, default rotational directions (e.g., clockwise or counterclockwise), and/or similar features for the turntable assembly 122, 222.

The device configuration settings 308 may include maximum/full magazine 132 cup 50 counts or associated weights, rotation speeds and/or increments or rotation for the magazine 132, cup alignment calibration, and power consumption thresholds. In some examples, the device configuration settings 308 for the ice dispensing station 180 include default ice quantities associated with various cup 50 sizes, run times for the dispensing valve 181, and/or the agitator 184 settings. As another example, the device configuration settings 308 may include set point temperatures for the non-carbonated and carbonated water distributed by the sources 197, 198, default flow rate, flow rate change increments, run times associated with the various cup 50 sizes, reaction time, and other similar features for the beverage dispensing station 190. In some examples, the device configuration settings 308 for the lidding and printing assembly 200 include printing settings such as alignment, font, text size, and the like. The device configuration settings 308 for the lidding and printing assembly 200 may additionally or alternatively include heat setpoints for the sealer bulbs 250, dispensing timing for the sealing film 244, and the like.

The device configuration settings 308 can be programmed by a user via the user device 111 or may be received as part of a packaged update from the remote computing system 113. For example, when a user, installer, or provider adjusts any one of the above settings via the user device 111 or the remote computing system 113, the changed information may be communicated to controller 300 via the communications interface 324 and stored on the device configuration settings 308 circuit.

The controller 300 is shown to include network configuration settings 310 stored on the memory 306. The network configuration settings 310 may define the types of communications used by controller 300 (e.g., infrared, Wi-Fi, Ethernet, USB, etc.) and/or the network locations of various external components with which controller 300 communicates. For example, network configuration settings 310 may specify a wireless or wired network 10 to which controller 300 is connected (e.g., a LAN), and may include any network information (e.g., SSID, passwords, network key, authentication type, etc.) necessary to connect to the network 10. The network configuration settings 310 may also define whether controller 300 is set to receive remote configuration updates via network 10 from a networked data source, and may specify the network location (e.g., URL, IP address, etc.) of the networked data source. The network configuration settings 310 can be programmed by a user via the user device 111 or received as part of a packaged update from the remote computing system 113. As an added layer of security, in some embodiments, the controller 300 may define a communication channel for certain communications. For example, regarding adjusting turntable rotation speeds, the controller 300 may define that this setting can only be changed by the user device 111 when the user device 111 is coupled to the same network (e.g., a local area WI-FI network). As another example, only certain operating parameters may be controllable by the user device 111 and/or remote computing system 113. For example, the remote computing system 113 may be only able to access historical operation logs in order to prevent on site tampering of the beverage production system 100.

The controller 300 is shown to include an order parsing circuit 312. The order parsing circuit 312 may include order parsing logic that is applied to decode and interpret order data transmitted from a POS system 115 and/or the user device 111 (e.g., a mobile device). By way of example, the POS system 115 may transmit an order that includes food items, a small, carbonated beverage, and a large non-carbonated beverage with no ice. From this order, the order parsing circuit 312 may parse the beverage orders (e.g., a cup size, a beverage type, a desired ice quantity, special instructions, etc.) from the whole order and generate actionable instructions for the various components of the beverage production system 100. In an example embodiment, the order parsing circuit 312 parses a destination ID from the order based on where the order was received (e.g., drive-through, front counter, a server device, a mobile device, etc.). In this example, the order parsing circuit 312 may generate instructions for the lidding and printing assembly 200 to print the cup size, beverage type, and the destination ID onto a corresponding lid or sealing film lid. For example, the controller 300 may cause the printing assembly 200 to print the destination ID on the lid seal (e.g., drive-through which may be abbreviated “DT” and further include a value indicating the number of orders in a predefined time period, such as “DT1009” which indicates 1009 drive-through orders in the predefined time period). The destination ID and value may be stored in the memory 306 as part of an order log, which may be periodically transmitted via the communications interface to at least one of the user device 111 or the remote computing system 113.

The controller 300 is shown to include a beverage fill circuit 314. The beverage fill circuit 314 may be configured to regulate the flow of beverages through the beverage dispensing station 190. The beverage fill circuit 314 may control the amount of liquid dispensed into each cup 50 according to a beverage order. In some examples, the beverage fill circuit 314 includes default liquid dispensing volumes or default liquid dispensing times that correspond to one or more types of beverages. Such dispensing times and/or dispensing volumes may vary based beverage type. In some examples, the dispensing times and/or dispensing volumes are inputted by a user on the user device 111. In other examples, the dispensing volumes and/or dispensing times are received as part of a packaged update from the remote computing system 113.

In some embodiments, the sensors 301 of the beverage dispensing station 190 transmit data indicative of cup fill level to the beverage fill circuit 314. By way of example, the one or more sensors 301 associated with the first nozzle 194 and/or the second nozzle 196 may collect data regarding the volume of beverage dispensed by one or more of the nozzles 194, 196, the volume of beverage in a cup 50, and/or a fill level of beverage relative to the top of a cup 50. Such data may be transmitted periodically according to a preset interval (e.g., every 0.5 seconds, every second, every 2 seconds, etc.) for each dispensing iteration (e.g., for each beverage order). The beverage fill circuit 314 may utilize the data collected by the one or more sensors 301 to determine a first volume or fill level of beverage dispensed into a cup 50 by the first nozzle 194. The beverage fill circuit 314 may determine based on the first fill volume or fill level, a second volume of beverage to dispense into the cup 50. The beverage fill circuit 314 may use one or more of a model (e.g., a mathematical model, a machine learning model, an artificial intelligence model, etc.), or a lookup table that correlates an initial fill level to a remaining fill capacity volume, to determine the second volume of beverage to dispense. The beverage fill circuit 314 may then operate the second nozzle 196 of the beverage dispensing station to dispense the second volume of beverage into the cup 50. In this way, the beverage fill circuit 314 adjusts for varying first fill levels in the cup 50 and precisely dispenses a remaining amount of beverage. In example embodiments, the beverage fill circuit 314 adjusts the volume of liquid dispensed from the first nozzle 194 and/or the second nozzle 196 for each dispensing cycle (i.e., for each beverage order).

In some examples, the beverage fill circuit 314 receives orders that include multiple beverage flavors/types in a single beverage order. In such an example, the beverage fill circuit 314 may determine a ratio of syrup to liquid (i.e., “a flavor ratio”) to dispense using each or one of the first nozzle 194 and the second nozzle 196. For example, the beverage fill circuit 314 may receive a beverage order for half cola and half diet cola. In such an example, the beverage fill circuit 314 may operate the first nozzle 194 to distribute cola into a cup 50 until the sensor(s) 301 transmit data indicating that the cup 50 is half full. The beverage fill circuit 314 may then, upon the cup 50 moving below the second nozzle 196, operate the second nozzle 196 to fill the remaining half of the cup 50 with diet cola.

In other examples, the beverage fill circuit 314 may determine a syrup value/quantity (e.g., a volume, a weight, a dispense time value) to dispense from the flavoring sources 199 that corresponds to the user input ratio (e.g., an order from the POS system 115 and/or the user device 111 that is received by the controller 300 for processing and fulfilling). The syrup value may be for example, a specific volume (e.g., in milliliters) and/or a dispense time value (e.g., 1, 2, 5 seconds, etc.). In other examples, the syrup value is a mass of syrup to be dispensed. The mass of syrup to be dispensed my vary amongst syrup types depending on syrup density. For example, the beverage fill circuit 314 receives an order that includes a desired proportion of a first beverage type/flavor and a desired proportion of a second beverage type/flavor (e.g., x % Beverage 1, y % Beverage 2, etc.). The beverage fill circuit 314 may determine a first syrup value corresponding to the first beverage type/flavor and a second syrup value corresponding to the second beverage type/flavor according to the input ratio. In operation, the syrups are intermixed with liquid dispensed by the fluid sources 197, 198 in the distribution valve assembly 195 to create a mixed beverage that is dispensed through both the first nozzle 194 and the second nozzle 196. By way of example, for a beverage order for half cola and half diet cola, the first and second nozzles 194, 196 each dispense a mixed beverage that is half cola and half diet cola, rather than dispensing cola out of one nozzle and diet cola out of the other nozzle.

Referring still to FIG. 15, the controller 300 is shown to include a flush circuit 316. The flush circuit 316 may store data relating to a flush of one or both of the nozzles 194, 196. As referred to herein, “flush” or “flush cycle” means operating the beverage dispensing station 190 to dispense a cleansing liquid (e.g., water, carbonated water) through one or both nozzles 194, 196 with the purpose of removing residual syrup or beverage from a prior beverage dispensing cycle. The flush circuit 316 determines whether at least one of flush operating parameter is met (e.g., by monitoring operation of the beverage dispensing station 190). The flush operating parameters may define when a flush cycle is commanded or initiated. In operation, the controller 300 may receive operating data regarding operation of the beverage production system 100, compare the operating data to one or more flush parameters, and selectively initiate a flush cycle based on this comparison. Programmable features/settings associated with a flush/flush frequency time, flush activation time, flush duration, and the like may be stored by the flush circuit 316. Flush preferences can be programmed into the flush circuit 316 by a user via the user device 111 or may be received as part of a packaged update from the remote computing system 113. Further, the flush settings may be specific to the beverages dispensed by each nozzle 194 and 196. For example, for a darker beverage (e.g., a cola), the flush cycle may be relatively longer in duration than for a lighter colored beverage (e.g., lemonade). The predefined settings may be configurable to account for the differences in beverages dispensed by the beverage production system 100. Further, the user device 111 may include a manual flush option.

In one embodiment, the flush cycle is programmed to occur automatically by the flush circuit 316. For example, the flush circuit 316 may cause the flush cycle to occur after each time a beverage is dispensed from the nozzle 194 or 196, cause the flush cycle to occur after a predefined idle duration (e.g., one-hour of non-usage), cause the flush cycle to occur after a predefined amount of time or uses of the nozzles 194 or 196 (e.g., after two beverage dispensing cycles, after X minutes of activity, etc.), and/or some combination thereof. As another example, the frequency of the flush cycle may be a function of the dispensed beverage. As mentioned above, darker colored beverages may be associated with heavier flushes, such that the flush circuit 316 causes more frequent flushes (e.g., each time a darker colored beverage is dispensed) to occur. In contrast, if water or carbonated water is the dispensed beverage, the flush circuit 316 may cause the flush to occur after more dispense cycles or time uses. As still another example, the flush circuit 316 may cause a flush to occur each time there is a beverage change from the nozzle 194 and/or 196. For example, if three orders are received and the first two orders are for cola while the third order is for water, the flush circuit 316 does not cause a flush to occur between the first and second orders but does cause a flush to occur between the second and third orders. In each of these instances, the type of flushing fluid and/or duration of the flush is highly programmable.

Additionally or alternatively, the user device 111 and/or beverage production system 100 itself may include a manual flush option for the nozzles 194 and/or 196. The manual flush option may be structured as a physical button or switch on the beverage production system 100 and/or be a touchscreen button on the user device 111. The manual flush option may be actuatable by the user to manually cause the flush cycle to occur. The button may be specific to all nozzles or multiple buttons may be used to cause / enable a flush cycle to occur selectively with each nozzle. Further, the user device 111 may include an option to customize the flush, such as controlling a temperature of the flushing fluid, a type of flushing fluid, a duration of the flush, and so on.

By way of example, the flush circuit 316 may initiate a flush cycle after the beverage dispensing station 190 dispenses a dark beverage from one or both nozzles 194, 196, or based on a preset schedule (e.g., hourly, semi-daily, daily, etc.). During a flush cycle, the flush circuit 316 transmits a control signal to the cup dispensing station 130 to prevent the cup dispensing station 130 from dispensing a cup 50 onto the turntable assembly 122, 222 during one or more rotations of the turntables 124, 126. As a result, at least one cup receptacle 125 is left empty. The flush circuit 316 may further transmit a control signal to the ice dispensing station 180 to prevent the ice dispensing station 180 from dispensing ice into the empty cup receptacles 125. Once one of the empty cup receptacles are aligned with one of the nozzles 194, 196, the flush circuit 316 operates the beverage dispensing station 190 to dispense water or carbonated water from the fluid sources 197, 198 through the aligned nozzle(s) 194, 196. The flush circuit 316 may further transmit a control signal to the lidding and printing assembly 200 to prevent the lift assembly 280 from lifting the empty cup receptacles and to prevent the lidding assembly from dispensing a lid or sealing film 244.

The controller 300 is shown to include a fault detection circuit 318 and a fault log 320. In example embodiments, the fault detection circuit 318 stores threshold values related to one or more components of the beverage production system 100. The fault detection circuit 318 may be communicatively coupled with one or more sensors disposed on or near the various components of the beverage production system 100. In example embodiments, the fault detection circuit 318 receives continuous input (e.g., every second, every minute, every two minutes, etc.) from one or more sensors disposed on or near the various components of the beverage production system 100. The fault detection circuit 318 may determine, based on the sensor data, whether a fault has occurred. The fault detection circuit 318 may determine a fault has occurred by comparing sensor data to preset thresholds, by applying a machine learning model, rules-based logic, a statistical model, and/or the like. In some examples, the fault detection circuit 318 determines a possible cause of the fault and/or a recommendation for resolving the fault.

In example embodiments, the fault detection circuit 318 transmits an instance of a detected fault along with relevant associated data (e.g., timestamp, location, fault type, etc.) to the fault log 320. Additionally or alternatively, the fault detection circuit 318 may transmit the instance of the detected fault to the user device 111 and/or the remote computing system 113. In some examples, the fault log 320 transmits a log of each instance of a detected fault over a predetermined time period (e.g., hourly, daily, weekly, etc.) to the user device 111 or the remote computing system. The controller 300 may cause a display device associated with the user device 111 or the remote computing system 113 to display a notification of an instance of a detected fault and/or a graphical representation of the log of faults transmitted by the fault log 320.

For example, the fault detection circuit 318 may store, or receive from the memory 306, thresholds or setpoints regarding operational parameters associated with the drivers 141, 143 of the turntable assembly 122, 222. As an example, the fault detection circuit 318 may detect a fault if one of the drivers 141, 143 is engaged but no rotation is detected in the corresponding turntable 124, 126. As another example, the fault detection circuit 318 may detect a fault responsive to the temperature or power draw of the drivers 141, 143 exceeding the predefined threshold. Responsive to detecting a fault associated with the drivers 141, 143, the fault detection circuit 318 may transmit a recommendation, for example, to check for a mechanical obstruction, to the user device 111. Additionally or alternatively, the fault detection circuit 318 may transmit the fault and data associated with the fault to the fault log 320, the user device 111, and/or the remote computing system 113.

The fault detection circuit 318 may monitor parameters associated with the cup dispensing station 130. As an example, the fault detection circuit 318 may detect a fault in the de-nesting assembly 164 responsive to the power draw of the driver(s) 162 not satisfying one or more predefined thresholds. For example, if the power draw exceeds a predefined high-power threshold, the fault detection circuit 318 may determine that a malfunction may occur with the driver(s) due to the excessive power draw and cease operation of the driver(s) as well as log a fault in the fault log. As another example, if the power draw is below a predefined low power threshold, the fault detection circuit 318 may determine that a malfunction has occurred because power consumption by the driver(s) should always be at or above the predefined low power threshold. This may alert an attendant that correction or troubleshooting may be needed. More particularly, if the power draw of the drivers 162 exceeds a threshold, the fault detection circuit 318 may transmit a recommendation, for example, to check the magazines 132 for jams (e.g., multiple cups 50 being stuck together within the magazines 132)(e.g., a notification on the user device 111 in the form of a message, a notification on the display of the beverage production system 100 itself, a notification to the remote computing system 113 which then alerts an on-site attendant or nearby technician, etc.). In some examples, the cup dispensing station includes sensors (e.g., optical sensors, weight sensors, proximity sensors, etc.) disposed in or near the cup dispensing station 130 that collect data associated with the cup 50 de-nesting process. Such data collected by the sensors may be transmitted to the controller 300 and compared to the threshold data stored on the memory 306.

As discussed above, faults detected by the fault detection circuit 318 may be transmitted to the fault log 320. In example embodiments, a user may access the fault log 320 via the user device 111. In some embodiments, a user may opt to transmit a fault or faults from the fault log 320 to the remote computing system 113. In other examples, the fault log 320 may transmit each fault detected or a set of faults detected within a predetermined time period (e.g., hourly, daily, weekly, monthly, etc.) to the remote computing system 113. In this way, the remote computing system 113 may utilize fault data to update, adjust, or change the device configuration settings 308 for the beverage production system 100.

Referring still to FIG. 15, the controller 300 is shown to include a usage information and supply circuit 322. In example embodiments, the usage information and supply circuit 322 tracks the quantity of materials used by each of the cup dispensing station 130, the beverage dispensing station, and/or the lidding and printing assembly 200. The usage information and supply circuit 322 may collect sensor data indicative of the quantity used and the quantity remaining of items/ingredients utilized by the cup dispensing station 130, the beverage dispensing station 190, and/or the lidding and printing assembly 200.

By way of example, the usage information and supply circuit 322 may receive an indication that the magazines 132 are full (e.g., a weight, a cup count, etc.). The device configuration settings 308 may, for example, include a full weight or cup count associated with the magazines 132. In some examples, the usage information and supply circuit 322 receives a count of cups 50 dispensed from a magazine 132 from a sensor positioned on/within the de-nesting assembly 164 (e.g., a Hall effect sensor measuring rotations of the drivers 162, optical sensors, limit switches, etc.). For example, the usage information and supply circuit 322 may receive rotation information from a Hall effect sensor measuring the rotations of the drivers 162. The usage information and supply circuit 322 may then calculate the number of dispensed cups 50 based on the number of rotations transmitted from the Hall effect sensor, where each full rotation of the driver corresponds to a predefined number of cups being dispensed (e.g., based on experimental data correlating rotations to cups dispensed such as the predefined number being one cup, two cups, etc.). In another example, the usage information and supply circuit 322 may receive a signal from an optical sensor positioned near the de-nesting assembly 164 (e.g., on the outer housing 163, on or below the corresponding receptacles 136, etc.). The optical sensor detects each cup 50 as each cup is dispensed by registering when a cup 50 passes through its detection field. Similarly, the usage information and supply circuit 322 may utilize on a limit switch that is triggered each time a cup 50 is dispensed from the magazine 132. The usage information and supply circuit 322 utilizes the data transmitted from the sensor(s) to track each cup dispensed by the cup dispensing station 130 and adjust a cup count for each magazine 132 accordingly. Upon a particular cup size falling below a preset minimum threshold (e.g., 10 or fewer cups of a particular cup size remaining), the usage information and supply circuit 322 may transmit a notification to the user device 111 indicating the particular magazine 132 and associated cup 50 size is running low.

In other examples, the usage information and supply circuit 322 receives a weight value regarding a current weight of the cups 50 in a magazine 132 from a weight sensor. In some examples, a weight sensor is positioned in each magazine 132. In other examples, a weight sensor, such as a load cell, is positioned on/within the de-nesting assembly 164 to measure the weight of the cups 50 exerted on the de-nesting assembly 164. The usage information and supply circuit 322 may compare a current magazine weight transmitted from the weight sensor(s) to a preset full magazine weight value. When the current weight falls below a predefined minimum weight threshold in a magazine 132, the usage information and supply circuit 322 may send a notification to the user device 111 to refill the magazine 132 with cups 50. In some examples, the usage information and supply circuit 322 may automatically order cups 50 in a particular size responsive to determining that a magazine 132 is running low (e.g., based on a determined weight of the cups in the magazine, a fill level detected (e.g., via a hall effect sensor), or another methodology).

As another example, for the beverage dispensing station 190, the usage information and supply circuit 322 tracks syrup or liquid ingredient quantities by measuring the volume or weight of materials dispensed through the flavoring sources 199. In example embodiments, the usage information and supply circuit 322 receives data indicative of an amount of syrup used within a predetermined time from the sensors 301 (e.g., since install of a full syrup container, use within an hour, a day, a week, a month, etc.). In one embodiment, a flow rate sensor(s) is included in the beverage production system 100 (e.g., proximate the nozzles 194 and/or 196, in the syrup conduit, a combination thereof, some other location, etc.). The flow rate sensor may track a flow rate of syrup and/or other liquid ingredients dispensed over a period of time. Using the flow rate and the period of time, the usage information and supply circuit 322 determines an amount dispensed over time. As another example, at least one ultrasonic sensor may be disposed by the syrup and/or liquid ingredient reservoir to track fill levels over time. The usage information and supply circuit 322 may compare the amount of syrup used to an initial syrup quantity to determine the quantity of syrup remaining (e.g., a difference between an initial quantity subtracted by the determined used quantity for the period of time, an absolute reading from the ultrasonic sensor mentioned above, etc.). In some examples, the usage information and supply circuit 322 regularly transmits (e.g., after each dispensing cycle, every 15 minutes, every hour, daily, etc.) a quantity of syrup remaining for each syrup associated with the beverage production system 100 to the user device 111. When the quantity of syrup remaining falls below a minimum threshold, the usage information and supply circuit 322 may transmit a notification to the user device 111. In some examples, the usage information and supply circuit 322 may automatically order syrups responsive to determining that a syrup's remaining quantity falls below the minimum threshold.

In some examples, the usage information and supply circuit 322 may aggregate usage information over predetermined time periods (e.g., daily, weekly, monthly, quarterly, yearly, etc.). The usage information and supply circuit 322 may determine usage trends over time periods. By way of example, the usage information and supply circuit 322 may determine usage trends using statistical methods, data analysis, historical data comparisons, machine learning models, or the like. Based on the usage trends, the usage information and supply circuit 322 may generate order recommendations and transmit the order recommendations to the user device 111. For example, if a particular beverage type is more popular in one quarter relative to other quarters, the usage information and supply circuit 322 may recommend that a user order an additional quantity of syrup corresponding to the beverage type to better match anticipated demand. In some examples, the order parsing circuit 312 may integrate/communicate with the usage information and supply circuit 322. For example, responsive to receiving an order transmitted by the order parsing circuit 312, the usage information and supply circuit 322 may check inventory levels and alert the remote computing system 113 and/or the user device 111 if items associated with the order are running low or require replenishment.

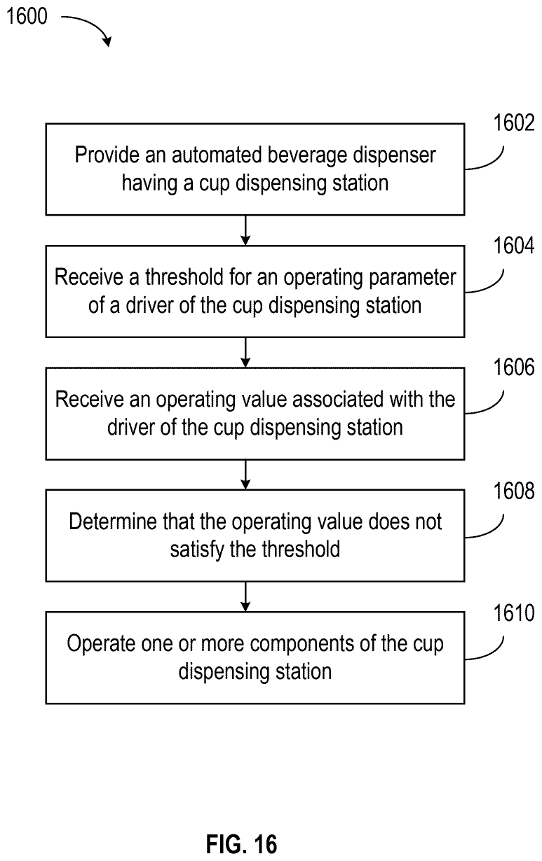

Referring now to FIG. 16, a flow diagram of a method 1600 for operating an automated beverage dispenser (i.e., the beverage production system 100) is shown, according to an example embodiment. A controller (e.g., the controller 300) associated with the automated beverage dispenser performs the method 1600, or parts thereof, according to some embodiments.

At step 1602, a beverage production system 100 having a cup dispensing station 130 is provided. As described above, the cup dispensing station 130 includes one or more de-nesting assemblies 164 configured to de-nest cups 50 from a stack. The de-nesting assemblies 164 include a driving gear 168 is coupled to the driver 162. During operation, the driver 162 may rotate the driving gear 168 to thereby driving the de-nesting assembly 164 to move from a first position to a second position, thereby de-nesting a cup 50 from the stack. In some embodiments, the driver 162 comprises an electric motor; however, in other embodiments, the driver 162 may comprise a pneumatic motor, a hydraulic motor, etc.

At step 1604, the controller 300 receives a threshold for an operating parameter of the driver 162 (e.g., electrical current threshold, power draw threshold, temperature threshold, a rotations per minute (RPM) threshold, etc.). The threshold values may be predefined, for example, by a user via the user device 111 or may be received as part of a packaged update from the remote computing system 113. In other examples, the threshold value may be dynamically updated based on operating conditions or user input. For example, if the driver operates in a high-temperature environment, the threshold for temperature might be adjusted (e.g., decreased relative to a default threshold) based on ambient temperature to prevent overheating during extended operation.

At step 1606, the controller 300 receives an operating value associated with the driver 162. For example, the controller 300 may receive a measurement of AC or DC current in the driver 162 from a current sensor and/or a current transducer disposed in or on the driver 162. As another example, the controller 300 may receive a measurement of power drawn by the driver 162 from a power meter disposed in or on the driver 162. In some examples, a temperature sensor is disposed within the de-nesting assembly 164 (e.g., on a side 134a, 134b, on the housing of or inside the driver 162 etc.). The temperature sensor is configured to measure or receive information indicative of an operating temperature of the driver 162 and transmit the operating temperature to the controller 300. The driver 162 may also include a Hall effect sensor that measures the operating RPM of the driver 162 and transmits the RPM to the controller 300.

At step 1608, the controller 300 determines whether the received operating value(s) satisfies the predefined threshold value(s). The controller 300 may detect a fault responsive to determining that the operating values does not satisfy one or more or a predefined set of threshold values.

At step 1610, the controller 300 operates one or more components of the cup dispensing station 130 based the comparison of the operating value(s) to the predefined threshold(s). For example, the controller 300 may cease operation of the driver(s) 162 responsive to the operating values of the temperature, power draw, current, and/or RPM of the driver(s) 162 do not satisfy the corresponding threshold value. For example, if the power draw exceeds a predefined high-power threshold, the controller 300 may determine that a malfunction may occur with the driver(s) 162 due to the excessive power draw and cease operation of the driver(s) 162. As another example, if the power draw is below a predefined low power threshold, the fault detection circuit 318 may determine that a malfunction has occurred because power consumption by the driver(s) 162 should always be at or above the predefined low power threshold.

Additionally or alternatively, the controller 300 may transmit a notification to the user device 111 and/or the remote computing system 113 responsive to determining that at least one operating value does not satisfy the corresponding threshold. In some examples, the controller 300 transmits a notification on the user device 111 in the form of a message. Additionally or alternatively, the controller may operate a display of the beverage production system 100 itself to display a notification. The controller 300 may transmit the notification to the remote computing system 113 which then alerts an on-site attendant or nearby technician.

Beneficially, the method 1600 may mitigate or prevent potential malfunctions within the cup dispensing station 130, thereby reducing downtime and improving system reliability. For example, the method 1600 can prevent overheating or excessive power draw by ceasing the operation of the driver 162 when operating values such as temperature or current exceed predefined thresholds. This may prevent damage to the driver 162, thereby extending the lifespan of the cup dispensing station 130 and reducing maintenance costs.

In some examples, the controller 300 may transmit a control signal to the ice dispensing station 180, the beverage dispensing station 190, the lidding and printing assembly 200, and/or the turntable assembly indicating that the cup dispensing station 130 did not dispense a cup (e.g., by ceasing operation of the drivers 162). As a result, at least one cup receptacle 125 is left empty. The controller 300 may transmit a control signal to the ice dispensing station 180 to prevent the ice dispensing station 180 from dispensing ice into the empty cup receptacle 125. Similarly, the controller 300 transmits a control signal to the beverage dispensing station 190 to prevent the beverage dispensing station 190 from dispensing a beverage through the nozzle(s) 194, 196 once one of the empty cup receptacles are aligned with one of the nozzles 194, 196. The controller 300 may further transmit a control signal to the lidding and printing assembly 200 to prevent the lift assembly 280 from lifting the empty cup receptacles and to prevent the lidding assembly from dispensing a lid or sealing film 244.

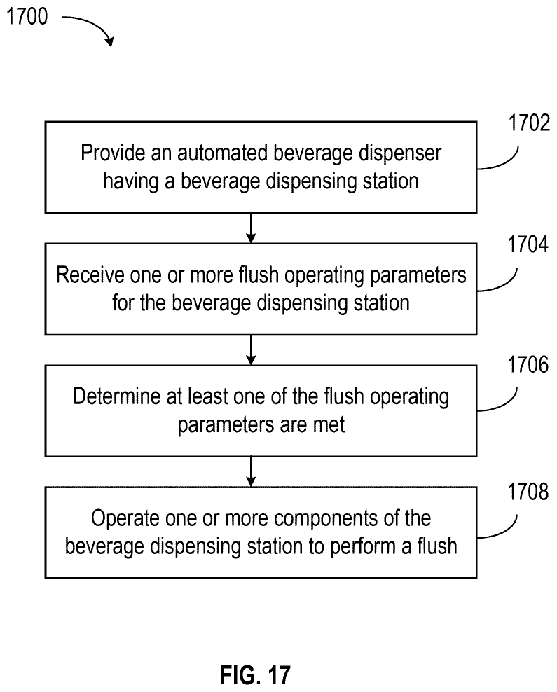

Referring now to FIG. 17, a flow diagram of a method 1700 for operating an automated beverage dispenser (i.e.., the beverage production system 100) to perform a flush cycle is shown, according to an example embodiment. A controller (e.g., the controller 300) associated with the automated beverage dispenser performs the method 1700, or portions thereof, according to some embodiments.

At step 1702, a beverage production system 100 having a beverage dispensing station 190 is provided. As discussed above, the controller 300 may include a flush circuit 316. The flush circuit 316 may operate one or more components of the beverage dispensing station 190 to dispense a cleansing liquid (e.g., water, carbonated water, etc.) through one or both nozzles 194, 196 (or however many nozzles are included with the beverage dispensing station 190) with the purpose of removing residual material/substance (e.g., syrup or beverage) from a prior beverage dispensing cycle.

At step 1704, the controller 300 receives one or more flush operating parameters. In some embodiments, the controller 300 is programmed with the one or more flush operating parameters via the user device 111 or the one or more flush operating parameters may be received as part of a package update from the remote computing system 113.

At step 1706, the controller 300 determines whether at least one of the flush operating parameters is met (e.g., by monitoring operation of the beverage dispensing station 190). The flush operating parameters may define when a flush cycle is commanded or initiated. In operation, the controller 300 may receive operating data regarding operation of the beverage production system 100, compare the operating data to one or more flush parameters, and selectively initiate a flush cycle based on this comparison.

The flush operating parameters may include an idle parameter defining an allowed idle duration (e.g., one-hour of non-usage, etc.) before a flush cycle is commanded, a number of nozzle uses/activity (e.g., after two beverage dispenses, after X minutes of activity, etc.) before a flush cycle is commanded, and/or some combination thereof. In this regard, the flush operating parameter may be based on usage thresholds, such as the number of beverages dispensed (e.g., after 100 beverages have been dispensed) or a specified operational time window (e.g., after 8 hours of continuous operation).

Similarly, the flush operating parameter may include temperature thresholds that cause a flush cycle when a temperature of one or more components of the beverage dispensing station 190 (e.g., the flavoring sources 199, the sources 197, 198, the distribution valve assembly 195, the nozzles 194, 196, the connective lines, etc.) do not satisfy the temperature threshold. For example, the controller may receive temperature data from a temperature sensor on the distribution valve assembly 195 and may compare the measured temperature to the predefined temperature threshold. If the temperature of the distribution valve assembly does not satisfy the threshold, then the controller 300 may initiate a flush. By way of example, a measured temperature of the distribution valve assembly 195 that is lower than a minimum temperature threshold may indicate a risk for liquid within the beverage dispensing station 190 freezing. In this example, the controller 300 initiates a flush cycle to increase the temperature of the distribution valve assembly 195. As another example, a maximum threshold may be set (e.g., based on beverage temperature standards, to prevent overheating, etc.). In this example, the controller 300 initiates a flush cycle to reduce the temperature of the distribution valve assembly 195 responsive to the temperature of the distribution valve assembly 195 exceeding the maximum threshold.

In still other embodiments, flow rate or pressure-based flush operating parameters may be utilized to trigger a flush (e.g., if the flow rate drops below a setpoint or the system detects a pressure drop below a minimum threshold a flush cycle is initiated). For example, the controller 300 receives a flow rate from a flow meter disposed on the connective lines of the beverage dispensing station 190. A flow rate below the minimum threshold may indicate a clog in the connective lines. Thus, the controller 300 may initiate a flush cycle responsive to the flow rate falling below the minimum threshold to, for example, clear a clog in the connective lines. Additional flush operating parameters that cause a flush cycle to be initiated may include a previously dispensed beverage type. For example, if a predefined dark colored beverage is dispensed, then the controller 300 subsequently initiates a flush cycle prior to dispensing another beverage. As another example, a sequence of dispensed beverage types, such as a predefined dark colored beverage followed by a predefined clear or light-colored beverage, may trigger a flush cycle to be initiated prior to dispensing the light-colored beverage.

At step 1708, the controller 300 operates one or more components of the beverage dispenser (e.g., one or more components of the dispensing station 190) to perform a flush operation (also refers to as a flush cycle). During the flush cycle and in some embodiments, the flush circuit 316 transmits a control signal to the cup dispensing station 130 to prevent the cup dispensing station 130 from dispensing a cup 50 onto the turntable assembly 122, 222 during one or more rotations of the turntables 124, 126. In other embodiments, the flush circuit 316 does not prevent dispensing of a cup 50 into the turntable assembly 122 or 222. In the former embodiment, at least one cup receptacle 125 is left empty. The flush circuit 316 may further transmit a control signal to the ice dispensing station 180 to prevent the ice dispensing station 180 from dispensing ice into the empty cup receptacles 125. Assuming the cup was prevented from being dispensed and an associated empty cup receptacle is (which would have received the dispensed cup) is aligned with one of the nozzles 194, 196, the flush circuit 316 operates the beverage dispensing station 190 to dispense a flushing fluid (e.g., water, carbonated water, etc.) from one or more of the fluid sources 197, 198 through the aligned nozzle(s) 194, 196. The flush circuit 316 may further transmit a control signal to the lidding and printing assembly 200 to prevent the lift assembly 280 from lifting the empty cup receptacles and to prevent the lidding assembly from dispensing a lid or sealing film 244. The flushed fluid may be captured by the drain and effectively diverted away from the beverage dispensing station 190. If the cup is allowed to be dispensed, the cup may receive the flushed fluid, yet the printing assembly and lift assembly are ceased from operation. An attendant may then remove and discard the cup containing the flushing fluid.

Beneficially, the method 1700 for operating an automated beverage dispenser to perform a flush cycle reduces or removes residual substances, such as syrup or remnants of a prior beverage, thereby preventing cross-contamination. Additionally, the removal of residual substances prevents clouding/discoloration of lighter or clear beverages dispensed after a darker colored beverage. Additionally, the use of temperature thresholds may mitigate or prevent potential issues like overheating or freezing. For example, if the temperature of one or more components of the beverage dispensing station 190 exceeds or falls below predefined limits, the controller can initiate a flush to either cool down the system or prevent freezing, thus enhancing the reliability of the beverage production system 100. Furthermore, the method benefits from incorporating flow rate and pressure-based parameters, which can address clogs in the connective lines.

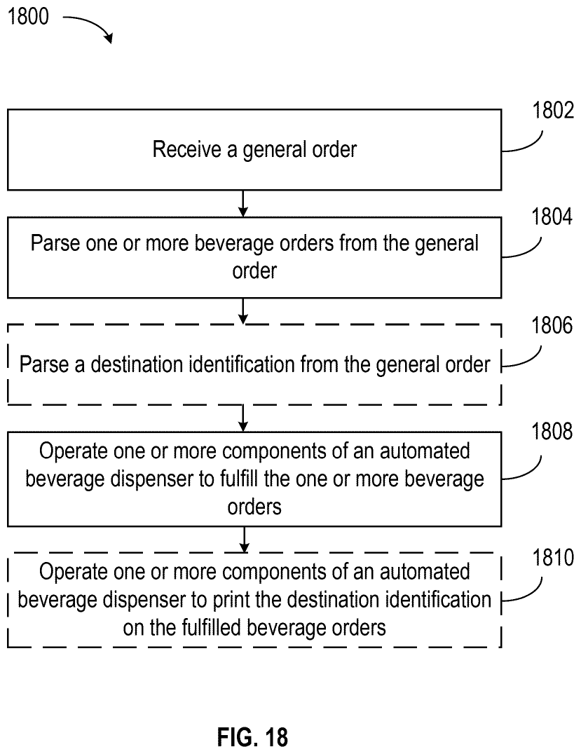

Referring now to FIG. 18, a flow diagram of a method 1800 for operating an automated beverage dispenser (i.e.., the beverage production system 100) to fulfill one or more beverage orders is shown, according to an example embodiment. A controller (e.g., the controller 300) associated with the automated beverage dispenser performs the method 1800, or parts thereof, according to some embodiments. As described above, the controller 300 may include an order parsing circuit 312 that decodes and interprets order data transmitted from a POS system 115 and/or the user device 111 (e.g., a mobile device).

At step 1802, the controller 300 receives an order (e.g., from the POS system 115, the user device 111, etc.) as a data packet. The order may be configured as a general order that includes one or more food items, beverage orders, merchandise, etc. At step 1804, the controller 300 parses the beverage order(s) from the general order. By way of example, the POS system 115 may transmit an order that includes food items, a small, carbonated beverage, and a large non-carbonated beverage with no ice. The parsing process may involve applying a parsing logic to identify the fields or sections in the general order data packet that correspond specifically to beverage-related information. The controller 300 uses predefined rules or templates to locate these fields, extract the relevant data (e.g., cup size, beverage type, ice quantity, special instructions, etc.). For example, the parsing logic may store a list of predefined beverage-related terms, such as beverage, cup, drink names (e.g., Pepsi®), etc., and when those predefined terms are detected, the controller 300 may identify a beverage order. As another example and when the general order is received, each beverage order may be associated with a specific unique identifier (e.g., a numeric, alpha, and/or alphanumeric code) that is encoded in the data packed. For example, a user may order a small cola at a drive-thru. The “small cola” is shown on a display screen for the user to confirm and/or an operator reads this information back to the user. Once confirmed, the small cola is entered into POS system (potentially along with other items) and transmitted as part of the data package to the controller 300. The small cola may be represented by a code, such as SXXYYYY, that defines the size and beverage type, which is then used to process the order by the beverage production system 100. Beneficially, the utilization of this code enables the controller 300 to seamlessly initiate dispensing of the correct beverage and parsing of the order.

At optional step 1806, the controller 300 parses a destination ID from the order based on where the order was received (e.g., drive-through, front counter, a server device, a mobile device, etc.). For example, the POS system 115 may include metadata or a tag within the order data that identifies the source or receiving location for the order. This metadata may include identifiers such as a location code (e.g., “DT” for drive-through, “FC” for front counter, “MD” for mobile device, etc.), which the controller 300 extracts and processes to determine where the beverages should be delivered. Alternatively, the order structure might include a specific field for the destination ID, and the controller 300 retrieves this information by identifying the field and extracting the corresponding value.

At step 1808, the controller 300 operates one or more components of the beverage dispensing station 190 to fulfill the beverage order(s) parsed from the general order. Specifically, as described above, the cup dispensing station 130 may dispense cups 50 from magazines 132 into the turntable assembly 122. Thereafter, the cups 50 are aligned with the ice dispensing station 180, whereby ice is dispensed into the cups 50. In some instances, depending on the selected preferences for each requested beverage, ice may not be dispensed into a cup or cups 50 when aligned with the ice dispensing station 180. Next, the cups 50 and ice (if dispensed) are aligned with the beverage dispensing station 190, whereby the selected beverage is dispensed into the cups 50 (e.g., via nozzles 194, 196).

At optional step 1810, the controller 300 operates the lidding and printing assembly 200 to print the destination ID onto the sealing film 244 such that it is visible to a user and/or operator of the beverage dispensing station 190. Next, the controller 300 operates the turntable assembly 122, 222 to progress the cups 50 to the lidding and printing assembly 200, where the sealing film 244 is placed and secured on the cup (e.g., by heat sealing) such that the sealing film 244 forms a film lid. In applications where optional step 1810 is omitted, the controller may secure the sealing film 244 to the cup without printing the destination ID on the sealing film 244.

Beneficially, the method 1800 allows the controller 300 to parse and decode order data from various sources, such as POS systems or mobile devices, and translate that data into specific beverage orders. This allows the automated beverage dispenser to be integrated into a variety of existing systems. For example, a user may input orders on an existing POS system, on a mobile device, or directly onto a display integrated with the automated beverage dispenser. Additionally, the destination IDs may improve service speed and organization by clearly displaying a destination location (e.g., rather than relying on human memory).

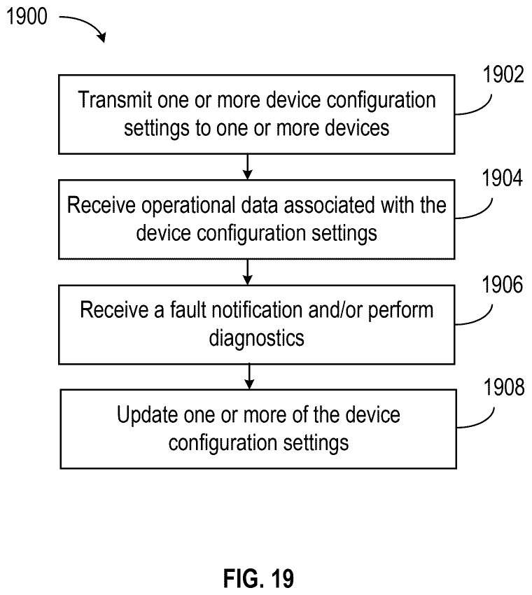

Referring to FIG. 19, a flow diagram of a method 1900 for operating an automated beverage dispenser (i.e.., the beverage production system 100) to fulfill one or more beverage orders is shown, according to an example embodiment. A remote system (e.g., the remote computing system 113) communicatively coupled to the automated beverage dispenser performs the method 1900, or portions thereof according to some embodiments.

At step 1902, the remote computing system 113 transmits device configuration settings to the beverage production system 100. In some examples, the device configuration settings are default settings input by a manufacturer of the beverage production system 100. In other examples, one or more of the device configuration settings are input by a user (e.g., via the user device 111). The device configuration settings may include programmable features/settings associated with the various components of the beverage production system 100, such as the turntable assembly 122, 222 (e.g., a predefined maximum and/or minimum rotational speed), the cup dispensing station 130 (e.g., a maximum speed for the driver to dispense cups), the ice dispensing station 180, the beverage dispensing station 190, the lidding and printing assembly 200, etc. The device configuration settings are discussed in greater detail with regards to the device configuration settings 308 shown in FIG. 15. At step 1904, the remote computing system 113 receives operational data from the controller 300 via the network. The operational data refers to information, data, etc. regarding operation of the beverage dispensing station 190 (e.g., a number of flush cycles, a number of beverage dispenses, a number of the types of beverage dispensed, a time since last service, a software identification version, etc.). The remote computing system 113 may continuously gather operational data to verify compliance with the established device configuration settings, which may dynamically change over time.

At step 1906, the remote computing system 113 receives fault notifications or other operational data indicating that a device has encountered an issue or is operating outside the predefined parameters. In some examples, the controller 300 compares the operational data to one or more predefined thresholds. In response to the operational data not satisfying the predefined thresholds (e.g., exceeding a maximum threshold, falling below a minimum threshold) the controller 300 records a fault. The fault is transmitted to the remote computing system 113, according to some embodiments. For instance, if the driver 162 experiences excessive current draw, a fault signal is sent from the controller 300 to the remote computing system 113. Alternatively or additionally, the remote computing system 113 analyze the operational data transmitted by the controller 300 at step 1904. The remote computing system 113 may use the operational data to troubleshoot current faults, identify fault trends, and/or predict potential future faults.

At step 1908, the remote computing system 113 updates the device configuration settings based on the received operational data and received faults. This step may involve dynamically adjusting operational parameters based on fault trends or manual intervention by a system administrator. For instance, after detecting repeated instances of overheating in a specific driver 162, the remote computing system 113 may lower the maximum threshold current draw or temperature threshold for that driver 162, thereby reducing the risk of future faults. The remote computing system 113 can push these updates to the beverage production system 100 remotely (e.g., without requiring manual reconfiguration on-site). The device configuration settings updates can be implemented automatically, or upon a user choosing to install updates (e.g., via a selection on the user device 111).

Beneficially, the method 1900 allows device configuration settings of the automated beverage dispenser to be remotely managed. For example, a single provider may push updates via the remote computing system 113 to an automated beverage dispensers to remedy, mitigate, or prevent faults in the automated beverage dispenser. In this way, the remote computing system may eliminate or reduce the need for manual intervention on-site, which reduces downtime and increases operational efficiency.

As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An automated beverage dispenser, the automated beverage dispenser comprising:
a cup dispensing station configured to dispense cups for use, the cup dispensing station comprising:
a housing;
a plurality of cups positioned within the housing, the plurality of cups being positioned in a nested relationship; and
a driver configured to de-nest a cup from the plurality of cups; and
a controller comprising one or more processing circuits having one or more memory devices coupled to one or more processors, the one or more memory devices configured to store instructions thereon that, when executed by the one or more processors, cause the one or more processors to:
receive a predefined threshold regarding an operating parameter of the driver;
receive a value regarding operation of the driver;
determine that the value regarding operation of the driver exceeds the predefined threshold; and
responsive to determining that the value exceeds the predefined threshold, cease operation of the driver to stop de-nesting cups from the plurality of cups.

2. The automated beverage dispenser of claim 1, wherein the one or more memory devices are further configured to store instructions thereon that, when executed by the one or more processors, cause the one or more processors to transmit, to a user device, a notification regarding the value regarding operation of the driver exceeding the predefined threshold.

3. The automated beverage dispenser of claim 1, wherein the one or more memory devices are further configured to store instructions thereon that, when executed by the one or more processors, cause the one or more processors to:
responsive to determining that the value exceeds the predefined threshold, determine a fault has occurred;
generate a recommendation for resolving the fault; and
transmit the recommendation to a user device.

4. The automated beverage dispenser of claim 1, wherein the one or more memory devices are further configured to store instructions thereon that, when executed by the one or more processors, cause the one or more processors to:
record an instance of a fault in a fault log responsive to determining that the value regarding operation of the driver exceeds the predefined threshold; and
transmit the instance of the fault to a remote computing system that is remotely located relative to the automated beverage dispenser.

5. The automated beverage dispenser of claim 1, wherein the predefined threshold is at least one of (a) a temperature, (b) a power draw, (c) an electrical current draw, or (c) rotations per minute (RPM ).

6. The automated beverage dispenser of claim 1, further comprising:
a beverage dispensing station configured to dispense a beverage into a cup;
wherein the one or more memory devices are further configured to store instructions thereon that, when executed by the one or more processors, cause the one or more processors to:
responsive to determining that the value regarding operation of the driver of the cup dispensing station exceeds the predefined threshold, transmit a control signal the beverage dispensing station indicating that a cup was not de-nested from the plurality of cups; and
operate the beverage dispensing station to cease operation of one or more valves and one or more nozzles.

7. The automated beverage dispenser of claim 6, further comprising:
a turntable assembly configured to receive the cups dispensed by the cup dispensing station and rotate to align the cups with the beverage dispensing station;
wherein the one or more memory devices are further configured to store instructions thereon that, when executed by the one or more processors, cause the one or more processors to:
responsive to determining that the value regarding operation of the driver of the cup dispensing station exceeds the predefined threshold, transmit a control signal the turntable assembly indicating that a cup was not de-nested from the plurality of cups; and
operate the turntable assembly to stop rotating.

8. An automated beverage dispenser, comprising:
a beverage dispensing station configured to dispense a beverage into a cup, the beverage dispensing station comprising:
one or more valves; and
at least one nozzle; and
a controller comprising one or more processing circuits having one or more memory devices coupled to one or more processors, the one or more memory devices configured to store instructions thereon that, when executed by the one or more processors, cause the one or more processors to:
dispense a first volume of beverage into the cup using the at least one nozzle;
receive, from one or more sensors, an indication of a beverage fill level of the dispensed first volume of beverage into the cup; and
based on the received indication of the beverage fill level of the dispensed first volume of beverage, cause a second volume of beverage to be dispensed into the cup using the at least one nozzle.

9. The automated beverage dispenser of claim 8, wherein the first volume of beverage corresponds with a different type of beverage relative to the second volume of beverage.

10. The automated beverage dispenser of claim 8, wherein the first volume of beverage corresponds with a same type of beverage as the second volume of beverage.

11. The automated beverage dispenser of claim 8, wherein the one or more memory devices are further configured to store instructions thereon that, when executed by the one or more processors, cause the one or more processors to:
receive an input regarding a flavor ratio for at least one of the first volume of beverage or the second volume of beverage, the flavor ratio comprising a first proportion of a first flavor and a second proportion of a second flavor;
determine a first syrup value based on the first proportion of the first flavor;
determine a second syrup value based on the second proportion of the second flavor;
operate the one or more valves to dispense the first syrup value and the second syrup value;
operate a distribution valve assembly to mix at least one of the first volume of beverage or the second volume of beverage using at least the first syrup value and the second syrup value;
operate the at least one nozzle to dispense the first volume of beverage; and
operate the at least one nozzle to dispense the second volume of beverage.

12. The automated beverage dispenser of claim 8, wherein the at least one nozzle comprises a first nozzle and a second nozzle, the first nozzle positioned upstream of the second nozzle.

13. The automated beverage dispenser of claim 12, wherein the first nozzle dispenses the first volume of beverage into the cup and the second nozzle dispenses the second volume of beverage into the cup.

14. The automated beverage dispenser of claim 8, wherein the one or more memory devices are further configured to store instructions thereon that, when executed by the one or more processors, cause the one or more processors to:
receive one or more beverage dispensing station flush operating parameters;
determine that one of the one or more beverage dispensing station flush operating parameters are met for at least one of the at least one nozzle; and
dispense fluid via the at least one nozzle to at least partly cleanse or flush the at least one nozzle.

15. The automated beverage dispenser of claim 14, wherein the one or more beverage dispensing station flush operating parameters include a predefined beverage, wherein in response to the predefined beverage being dispensed via the at least one nozzle, the fluid that least partly cleanses or flushes the at least one nozzle is subsequently dispensed.

16. The automated beverage dispenser of claim 14, wherein the one or more beverage dispensing station flush operating parameters include a predefined schedule that causes the fluid that least partly cleanses or flushes the at least one nozzle to be dispensed according to the predefined schedule.

17. The automated beverage dispenser of claim 14, wherein the one or more beverage dispensing station flush operating parameters include a temperature threshold, wherein in response to the temperature threshold not being satisfied, the fluid that at least partly cleanses or flushes the at least one nozzle is dispensed.

18. A controller for an automated beverage dispenser, the controller comprising one or more processing circuits having one or more memory devices coupled to one or more processors, the one or more memory devices configured to store instructions thereon that, when executed by the one or more processors, cause the one or more processors to:
receive, over a network, an order from a point of sale (POS) system;
parse, from the order, one or more beverage orders and a destination identification (ID);
operate one or more beverage dispenser devices of the automated beverage dispenser to dispense a cup and a beverage according to one of the one or more beverage orders;
operate a lidding and printing assembly of the automated beverage dispenser to print the beverage and the destination ID onto a sealing film; and
operate the lidding and printing assembly to couple the sealing film onto an open end of the cup filled with the beverage such that the sealing film forms a lid for the cup.

19. The controller of claim 18, wherein the destination ID is a location code corresponding to a location of the POS system from which the order was received.

20. The controller of claim 18, wherein the one or more beverage orders each include a cup size, a type of beverage, and a quantity of ice, and wherein the one or more memory devices are further configured to store instructions thereon that, when executed by the one or more processors, cause the one or more processors to operate the lidding and printing assembly to print at least one of (a) the cup size, (b) the type of beverage, or (c) the quantity of ice onto the sealing film.
